(19) United States
(12) Patent Application Publication
(10) Pub. No.: US 2018/0107795 A1
(43) Pub. Date: Apr. 19, 2018

(54) Tracking and Controlling Inter-System Processing Events Using Event Tokens

(71) Applicant: Liquid Payments, Inc., Fort Lauderdale, FL (US)

(72) Inventor: Shashi B. Kapur, Fort Lauderdale, FL (US)

(21) Appl. No.: 15/730,052

(22) Filed: Oct. 11, 2017

Related U.S. Application Data
(60) Provisional application No. 62/408,030, filed on Oct. 13, 2016.

(51) Int. Cl. G06F 19/00; G06F 17/30; G06F 21/62; G06Q 50/24; G06N 99/00

(52) U.S. Cl. CPC G06F 19/322; G06F 17/30002; G06N 99/005; G06Q 50/24; G06F 21/6245

(57) ABSTRACT

Methods, systems, computer-readable media, and apparatuses for using event tokens to track and control inter-system processing events associated with medical-related data are presented. A computing platform may receive adjudication information and generate an event token associated with a post-adjudication event. Subsequently, the computing platform may store the event token, generate an adjudication notification for a patient mobile device, and send the adjudication notification to the patient mobile device. Thereafter, the computing platform may receive a tokenized request and may generate and send a post-adjudication user interface associated with the post-adjudication event to the patient mobile device. Thereafter, the computing platform may receive post-adjudication response data and may generate a formatted command directing a remote event processing server to complete the post-adjudication event. Subsequently, the computing platform may send, to the remote event processing server, the formatted command directing the remote event processing server to complete the post-adjudication event.

### CROSS-REFERENCE TO RELATED APPLICATIONS

This application claims the benefit of and priority to U.S. Provisional Patent Application Ser. No. 62/408,030, filed Oct. 13, 2016, and entitled “Bot Based Adjudication And Settlement Of Medical Payments,” which is incorporated by reference herein in its entirety.

### BACKGROUND

Aspects of the disclosure relate to data processing, artificial intelligence, and using artificial intelligence-enabled data processing systems to process medical-related data. In particular, one or more aspects of the disclosure relate to using event tokens to track and control inter-system processing events associated with medical-related data.

Generating, tracking, controlling, and otherwise handling computer-processed events that affect multiple computer systems may present a number of technical challenges, such as ensuring loss-less data transfers across different computer systems while also optimizing for both processing power consumption and network bandwidth usage throughout the associated computing infrastructure. In many instances, these challenges are compounded when computer systems are handling private and confidential data, such as medical-related information, because maintaining the security and integrity of such data may be critically important to the underlying applications and achieving these goals may require using additional computing resources.

### SUMMARY

Aspects of the disclosure provide effective, efficient, scalable, and convenient technical solutions that address and overcome the technical problems associated with handling computer-processed events that affect multiple computer systems. In particular, one or more aspects of the disclosure relate to technical solutions for using event tokens to track and control inter-system processing events associated with medical-related data.

In accordance with one or more embodiments, a computing platform having at least one processor, a communication interface, and memory may receive adjudication information comprising a patient identifier, a visit identifier, and adjudication results data. Based on receiving the adjudication information, the computing platform may generate an event token associated with a post-adjudication event, and the event token associated with the post-adjudication event may include a unique identifier linking the post-adjudication event to the patient identifier, the visit identifier, and the adjudication results data. Subsequently, the computing platform may store the event token associated with the post-adjudication event in an event token database. Then, the computing platform may generate an adjudication notification for a patient mobile device and may send, via the communication interface, to the patient mobile device, the adjudication notification generated for the patient mobile device. Thereafter, the computing platform may receive, via the communication interface, from the patient mobile device, a tokenized request for a post-adjudication user interface associated with the post-adjudication event.

In response to receiving the tokenized request for the post-adjudication user interface associated with the post-adjudication event from the patient mobile device, the computing platform may generate the post-adjudication user interface associated with the post-adjudication event based on the patient identifier, the visit identifier, and the adjudication results data associated with the adjudication information. Then, the computing platform may send, via the communication interface, to the patient mobile device, the post-adjudication user interface associated with the post-adjudication event. After sending the post-adjudication user interface associated with the post-adjudication event to the patient mobile device, the computing platform may receive, via the communication interface, from the patient mobile device, post-adjudication response data associated with the post-adjudication event. Based on receiving the post-adjudication response data associated with the post-adjudication event, the computing platform may generate a formatted command directing a remote event processing server to complete the post-adjudication event. Subsequently, the computing platform may send, via the communication interface, to the remote event processing server, the formatted command directing the remote event processing server to complete the post-adjudication event.

In some embodiments, receiving the adjudication information may include receiving the adjudication information from a healthcare provider computing device via the communication interface. In some embodiments, receiving the adjudication information may include receiving the adjudication information from an adjudication bot.

In some embodiments, generating the adjudication notification for the patient mobile device may include accessing a patient profile linking the patient identifier with a device identifier corresponding to the patient mobile device to determine the device identifier corresponding to the patient mobile device. In some embodiments, generating the adjudication notification for the patient mobile device may include inserting, in the adjudication notification, a tokenized link corresponding to the event token associated with the post-adjudication event stored in the event token database.

In some embodiments, sending the adjudication notification generated for the patient mobile device to the patient mobile device may include sending the adjudication notification to the patient mobile device via a push notification service associated with the patient mobile device. In some embodiments, sending the adjudication notification generated for the patient mobile device to the patient mobile device may include sending the adjudication notification to the patient mobile device via one or more text messages.

In some embodiments, receiving the tokenized request for the post-adjudication user interface associated with the post-adjudication event from the patient mobile device may include receiving request information identifying the event token associated with the post-adjudication event stored in the event token database.

In some embodiments, receiving the post-adjudication response data associated with the post-adjudication event from the patient mobile device may include receiving response data indicating patient authorization to complete the post-adjudication event. In some embodiments, receiving the post-adjudication response data associated with the post-adjudication event from the patient mobile device may include receiving response data requesting a recurring event to complete the post-adjudication event. In some embodiments, receiving the post-adjudication response data associated with the post-adjudication event from the patient mobile device may include receiving response data defining new patient profile information.

In some embodiments, generating the formatted command directing the remote event processing server to complete the post-adjudication event may include generating at least one command for the remote event processing server and formatting the at least one command for the remote event processing server in accordance with a web-based application programming interface (API) provided by the remote event processing server. In some instances, generating the formatted command directing the remote event processing server to complete the post-adjudication event may include configuring the formatted command to direct the remote event processing server to debit a payment account linked to a patient associated with the post-adjudication event.

In some embodiments, prior to receiving the adjudication information, the computing platform may receive, via the communication interface, from a healthcare provider computing device, patient registration data associated with a first patient. Subsequently, the computing platform may generate a patient profile for the first patient based on the patient registration data received from the healthcare provider computing device. In some instances, after generating the patient profile for the first patient, the computing platform may identify data requesting an initial event in the patient registration data received from the healthcare provider computing device. Subsequently, the computing platform may process the initial event by generating and sending one or more formatted commands to the remote event processing server.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for using event tokens to track and control inter-system processing events associated with medical-related data in accordance with one or more example embodiments;

FIGS. 2A-2O depict an illustrative event sequence for using event tokens to track and control inter-system processing events associated with medical-related data in accordance with one or more example embodiments;

FIGS. 3-14 depict example graphical user interfaces for using event tokens to track and control inter-system processing events associated with medical-related data in accordance with one or more example embodiments; and

FIG. 15 depicts an illustrative method for using event tokens to track and control inter-system processing events associated with medical-related data in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

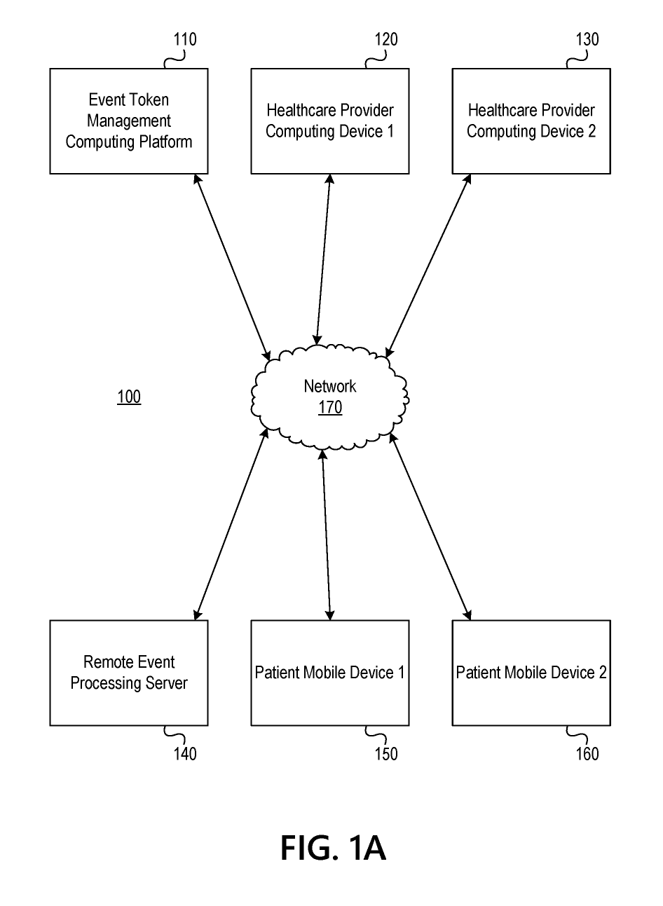

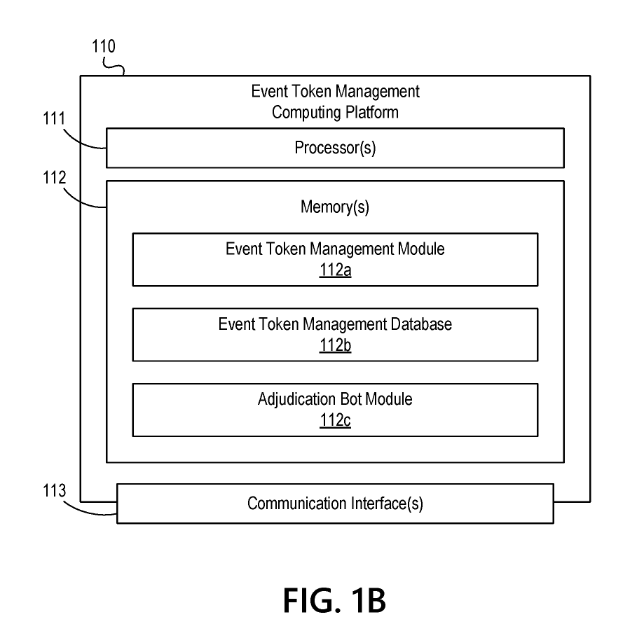

FIGS. 1A and 1B depict an illustrative computing environment for using event tokens to track and control inter-system processing events associated with medical-related data in accordance with one or more example embodiments. Referring to FIG. 1A, computing environment 100 may include one or more computer systems. For example, computing environment 100 may include an event token management computing platform 110, a first healthcare provider computing device 120, a second healthcare provider computing device 130, a remote event processing server 140, a first patient mobile device 150, and a second patient mobile device 160.

As illustrated in greater detail below, event token management computing platform 110 may include one or more computing devices configured to perform one or more of the functions described herein. For example, event token management computing platform 110 may include one or more computers (e.g., laptop computers, desktop computers, servers, server blades, or the like).

Healthcare provider computing device 120 may be a personal computing device (e.g., desktop computer, laptop computer) or mobile computing device (e.g., smartphone, tablet, wearable device) that may be linked to and/or used by a first healthcare provider user (e.g., a physician, a nurse, a physician office administrator) at a first healthcare provider location (e.g., a hospital, a clinic, a doctor's office). Healthcare provider computing device 130 may be a personal computing device (e.g., desktop computer, laptop computer) or mobile computing device (e.g., smartphone, tablet, wearable device) that may be linked to and/or used by a second healthcare provider user (e.g., a physician, a nurse, a physician office administrator) at a second healthcare provider location (e.g., a hospital, a clinic, a doctor's office). The second healthcare provider user may be different from the first healthcare provider user (e.g., a different physician, nurse, or physician office administrator), and the second healthcare provider location may be different from the first healthcare provider location (e.g., a different hospital, clinic, or doctor's office).

Remote event processing server 140 may be a server computer system that is owned, operated, and/or maintained by a third-party payment processing provider and/or payment network. In some instances, remote event processing server 140 may expose and/or provide one or more remotely-accessible computer-executable functions, such as via a web application programming interface (API), that can be invoked and/or otherwise used by other computer systems and/or devices in computing environment 100 to request, schedule, and/or process payment transactions (e.g., credit card payment transactions, debit card payment transactions, etc.). For example, such a web application programming interface may define a set of functions and associated syntax for such functions, and other computer systems and/or devices in computing environment 100 may connect to remote event processing server 140 and, while a connection or other communications link is established to remote event processing server 140, generate and/or send API calls and/or other commands to remote event processing server 140 in accordance with the defined syntax to direct and/or otherwise cause remote event processing server 140 to execute one or more functions of the set of functions that may be provided by remote event processing server 140.

Patient mobile device 150 may a personal computing device (e.g., desktop computer, laptop computer) or mobile computing device (e.g., smartphone, tablet, wearable device) that may be linked to and/or used by a first patient user (who may, e.g., be a patient of a healthcare provider who has visited, is visiting, or will visit the first healthcare provider location or the second healthcare provider location). Patient mobile device 160 may a personal computing device (e.g., desktop computer, laptop computer) or mobile computing device (e.g., smartphone, tablet, wearable device) that may be linked to and/or used by a second patient user (who may, e.g., be a patient of a healthcare provider who has visited, is visiting, or will visit the first healthcare provider location or the second healthcare provider location). The second patient user may, for instance, be a different user (e.g., a different patient) from the first patient user.

Computing environment 100 also may include one or more networks, which may interconnect one or more of event token management computing platform 110, healthcare provider computing device 120, healthcare provider computing device 130, remote event processing server 140, patient mobile device 150, and patient mobile device 160. For example, computing environment 100 may include a network 170, which may include one or more private networks, public networks, and/or sub-networks. In addition, network 170 may interconnect one or more of event token management computing platform 110, healthcare provider computing device 120, healthcare provider computing device 130, remote event processing server 140, patient mobile device 150, patient mobile device 160, and one or more other computer systems and/or devices connected to the one or more private networks, public networks, and/or sub-networks included in network 170.

In one or more arrangements, healthcare provider computing device 120, healthcare provider computing device 130, remote event processing server 140, patient mobile device 150, patient mobile device 160, and/or the other systems included in computing environment 100 may be any type of computing device capable of receiving a user interface, receiving input via the user interface, establishing one or more connections to one or more other computing devices, and communicating the received input to the one or more other computing devices while the one or more connections are established. For example, healthcare provider computing device 120, healthcare provider computing device 130, remote event processing server 140, patient mobile device 150, patient mobile device 160, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of event token management computing platform 110, healthcare provider computing device 120, healthcare provider computing device 130, remote event processing server 140, patient mobile device 150, and patient mobile device 160 may, in some instances, be special-purpose computing devices configured to perform specific functions.

Referring to FIG. 1B, event token management computing platform 110 may include one or more processor(s) 111, memory(s) 112, and communication interface(s) 113. A data bus may interconnect processor(s) 111, memory(s) 112, and communication interface(s) 113. Communication interface(s) 113 may be one or more network interfaces configured to support communication between event token management computing platform 110 and one or more networks (e.g., network 170). Memory(s) 112 may include one or more program modules having instructions that when executed by processor(s) 111 cause event token management computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of event token management computing platform 110 and/or by different computing devices that may form and/or otherwise make up event token management computing platform 110. In addition, memory(s) 112 may have, store, and/or include an event token management module 112a, an event token management database 112b, and an adjudication bot module 112c. Event token management module 112a may have, store, and/or include instructions that, when executed, direct and/or cause event token management computing platform 110 to use event tokens to track and control inter-system processing events associated with medical-related data, as discussed in greater detail below. Event token management database 112b may store information used by event token management module 112a and/or event token management computing platform 110 in using event tokens to track and control inter-system processing events associated with medical-related data and/or in performing other functions. Adjudication bot module 112c may have, store, and/or include instructions that, when executed, direct and/or cause event token management computing platform 110 to provide a self-learning engine that is configured to automatically adjudicate various aspects of health insurance claims and/or other medical benefits and output adjudication results information, as discussed in greater detail below. In one or more arrangements event token management module 112a, event token management database 112b, adjudication bot module 112c, and/or event token management computing platform 110 may be configured to be compliant with Health Insurance Portability and Accountability Act (HIPAA), Payment Card Industry Data Security Standard (PCI DSS), and/or one or more other laws, regulations, and/or standards, to ensure the privacy, confidentiality, security, and integrity of both the medical-related data, which may include patient data, and the payments data processed by event token management computing platform 110.

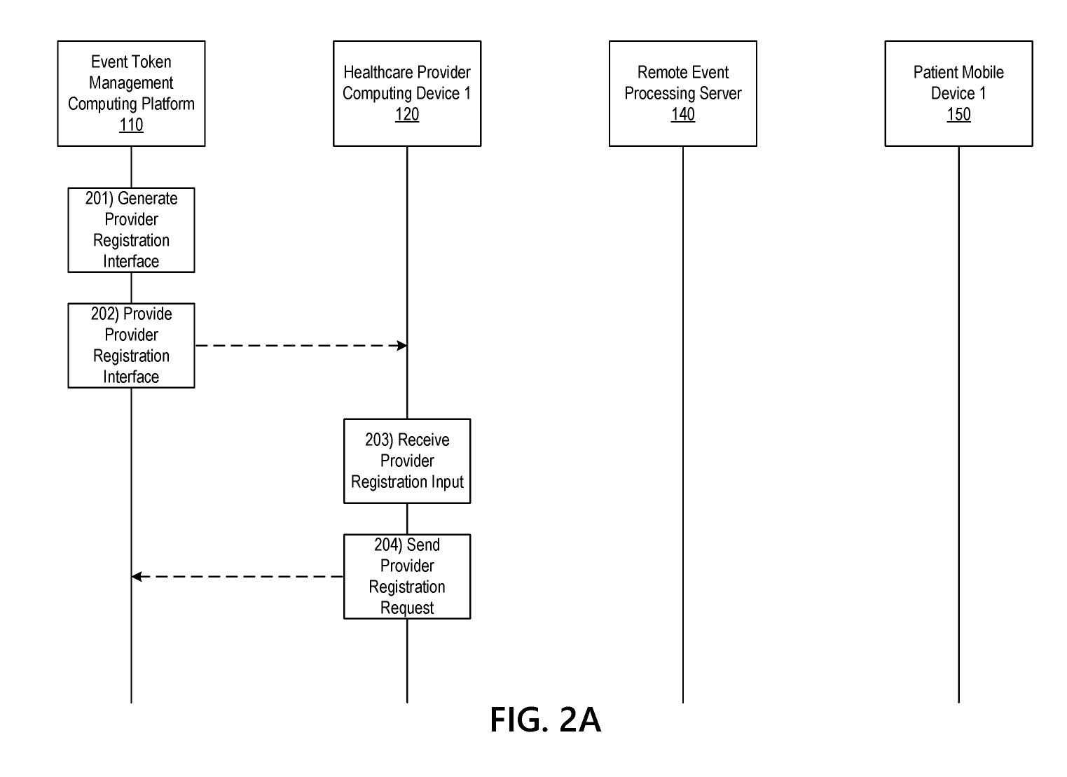

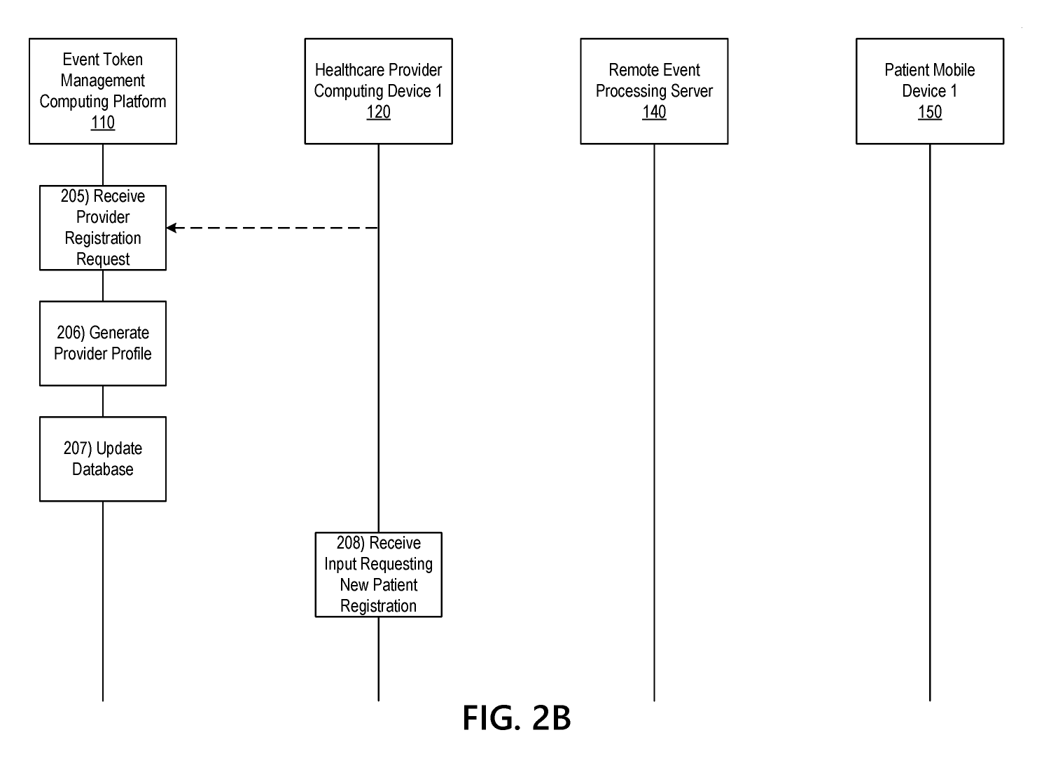

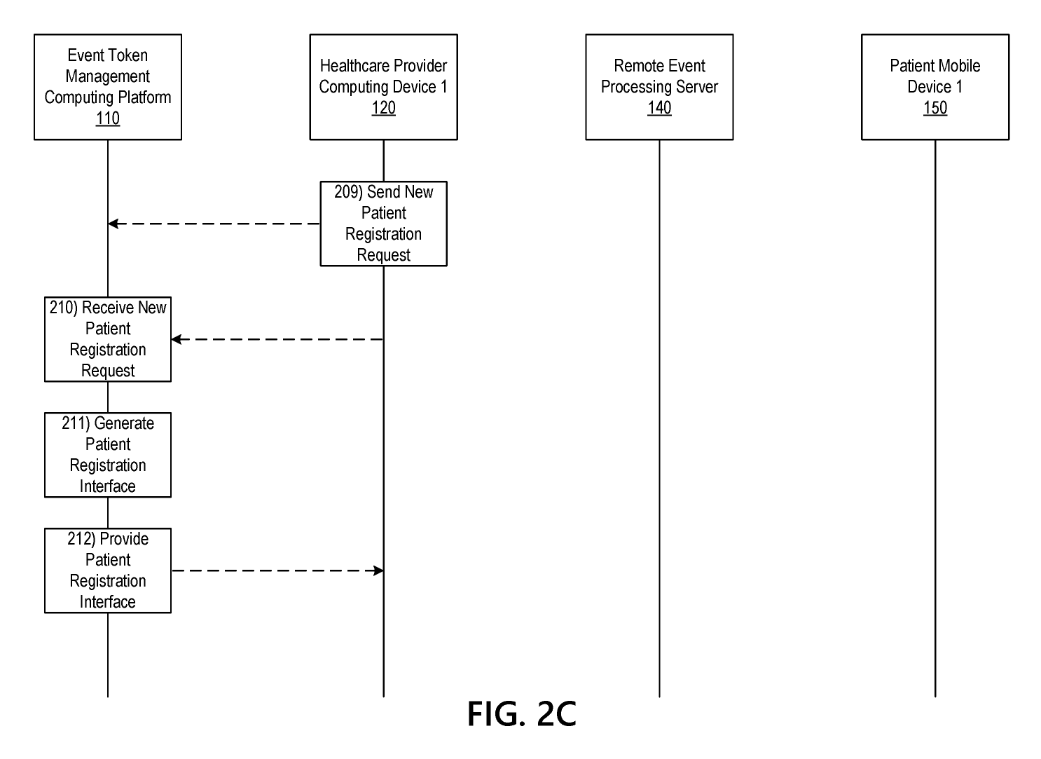

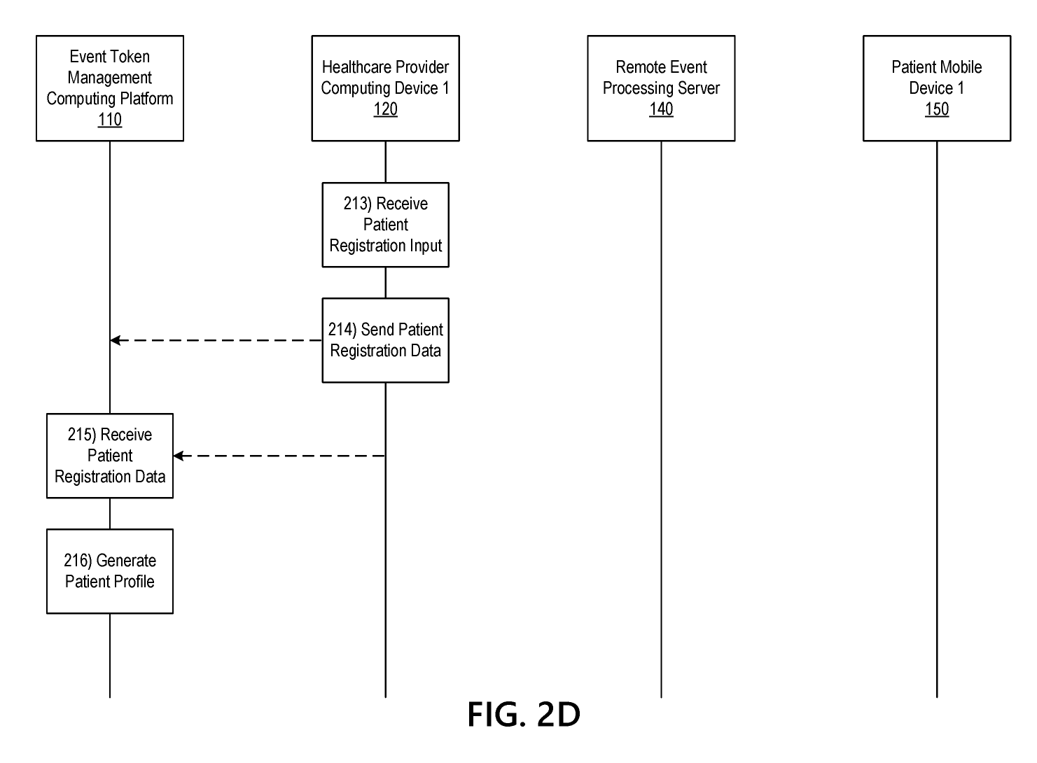

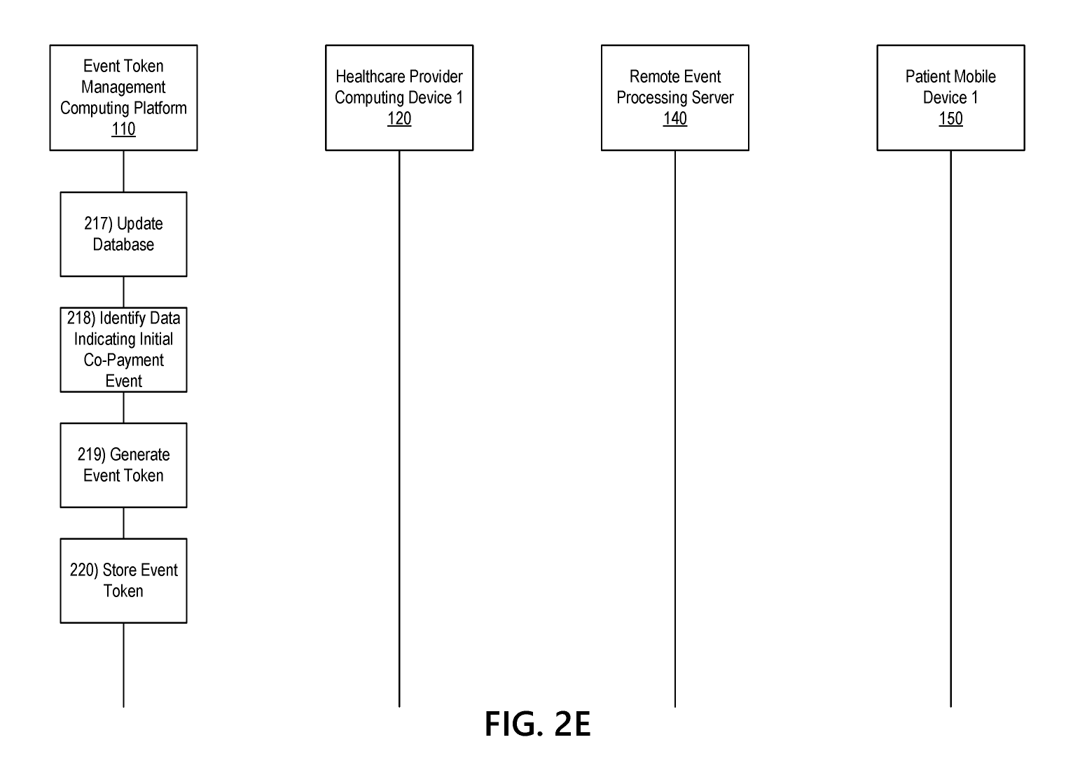

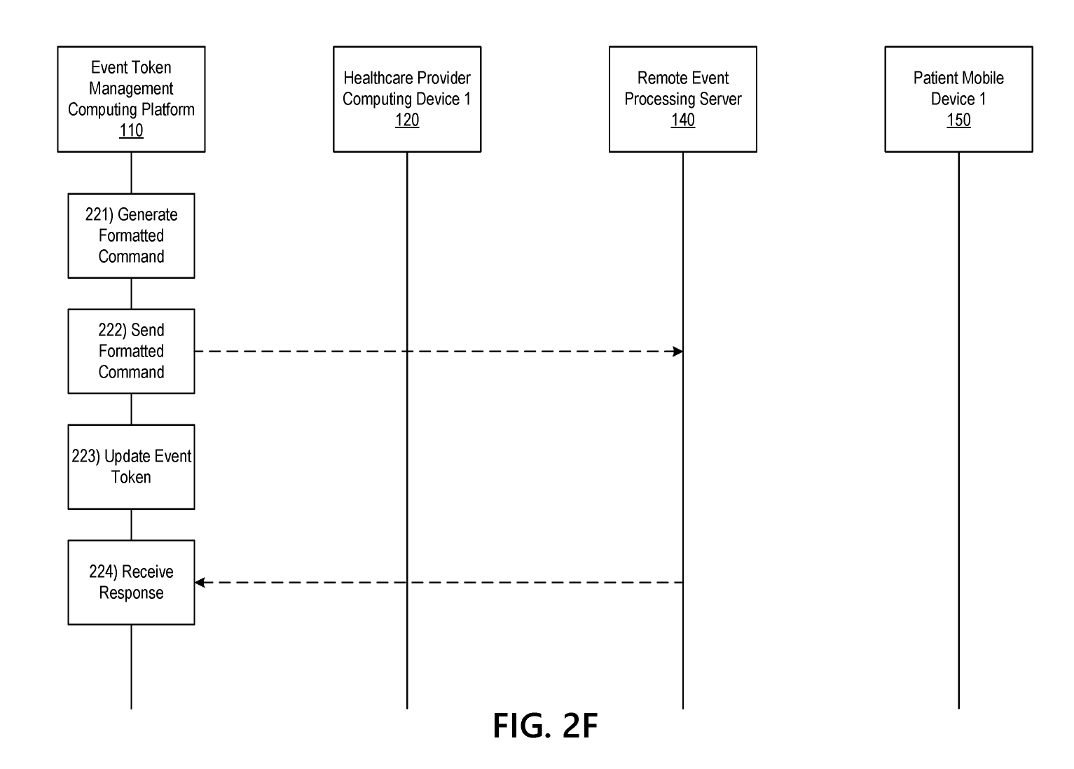

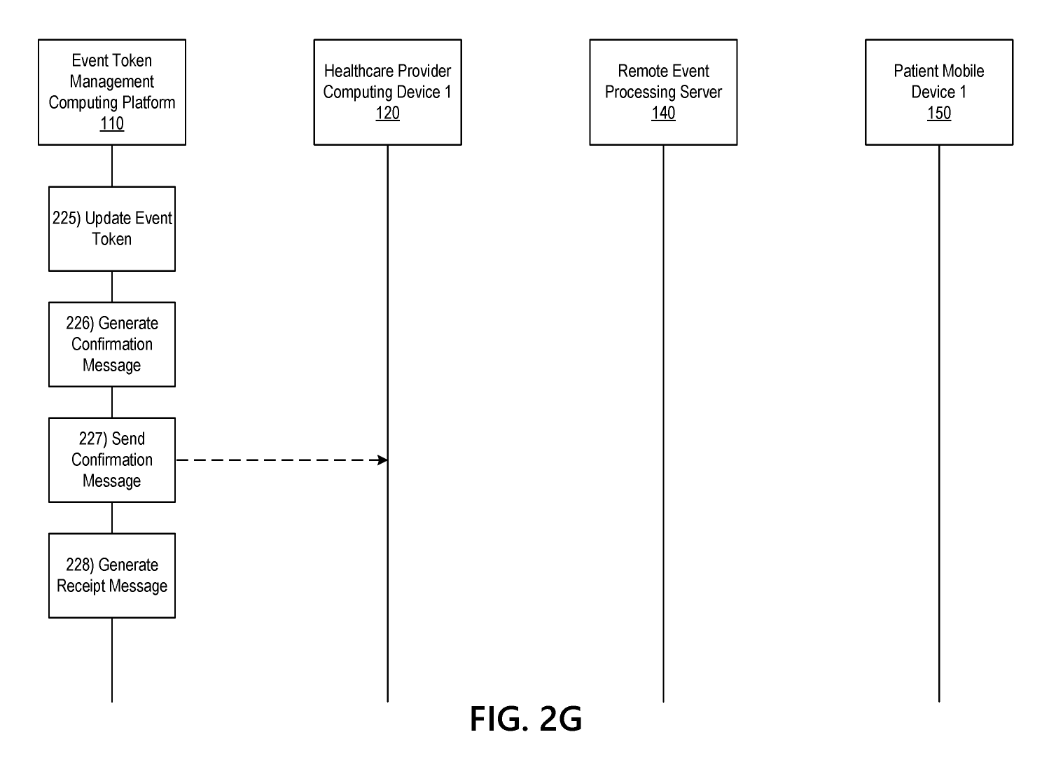

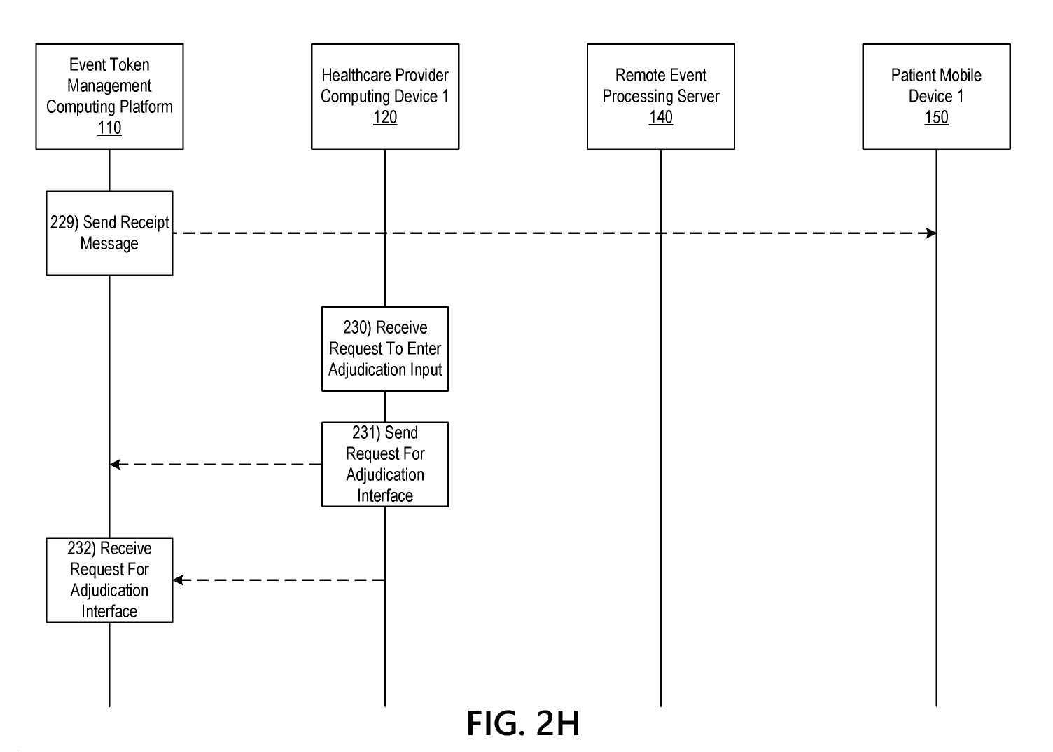

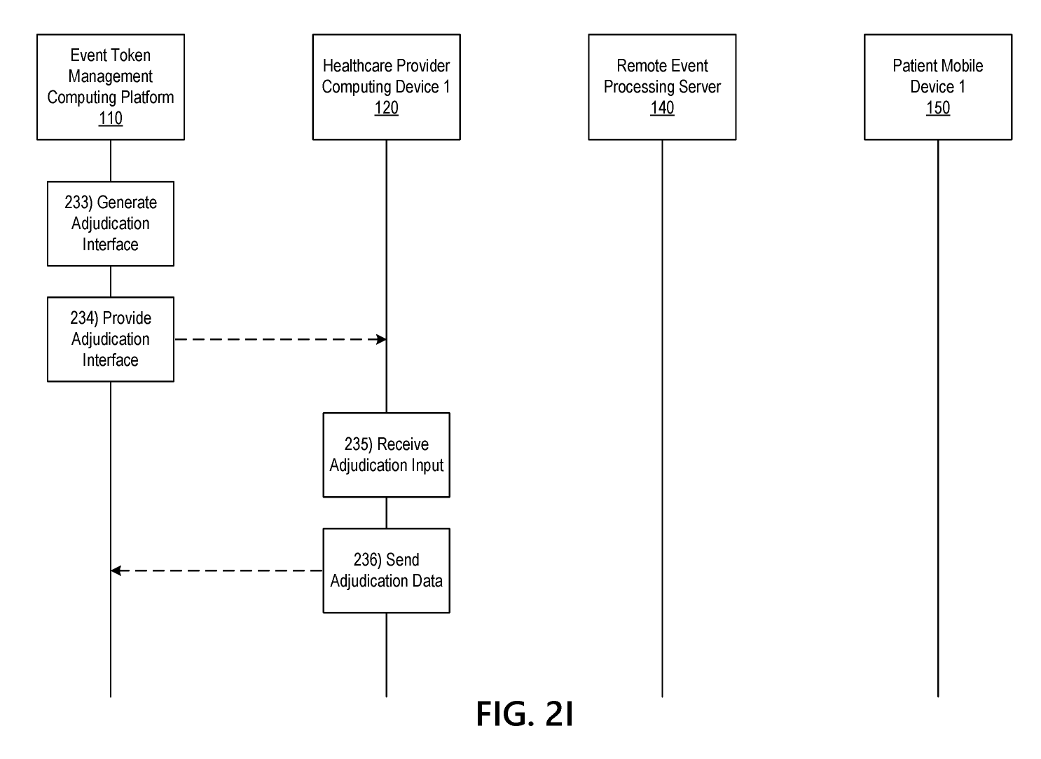

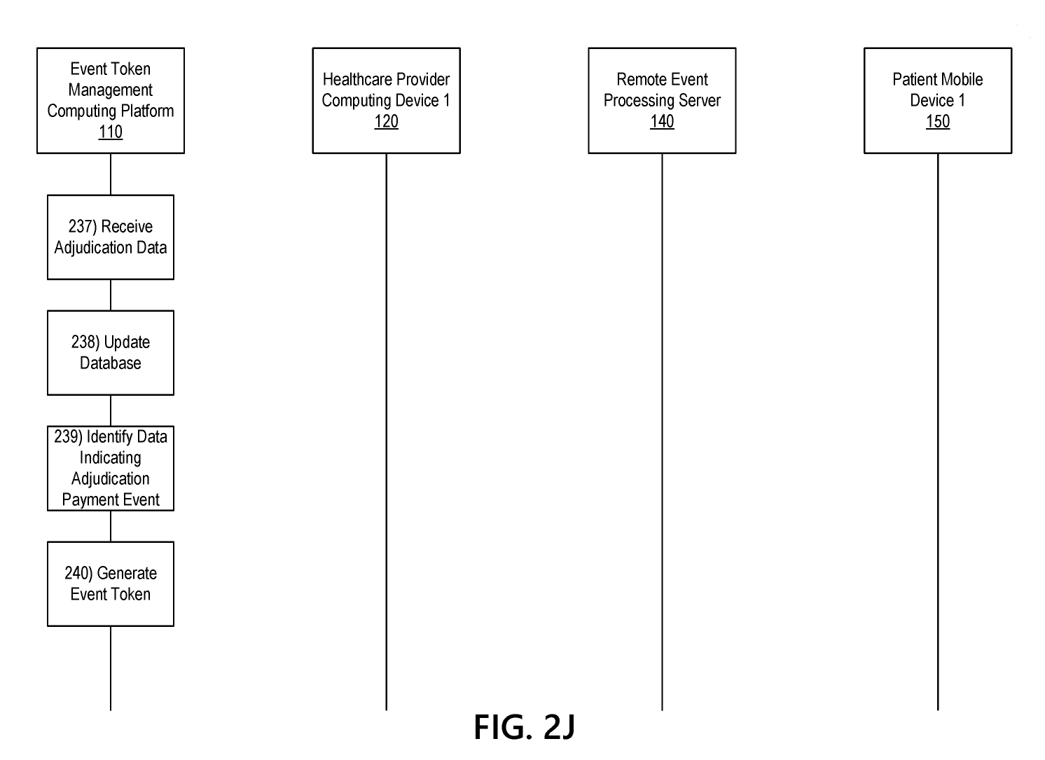

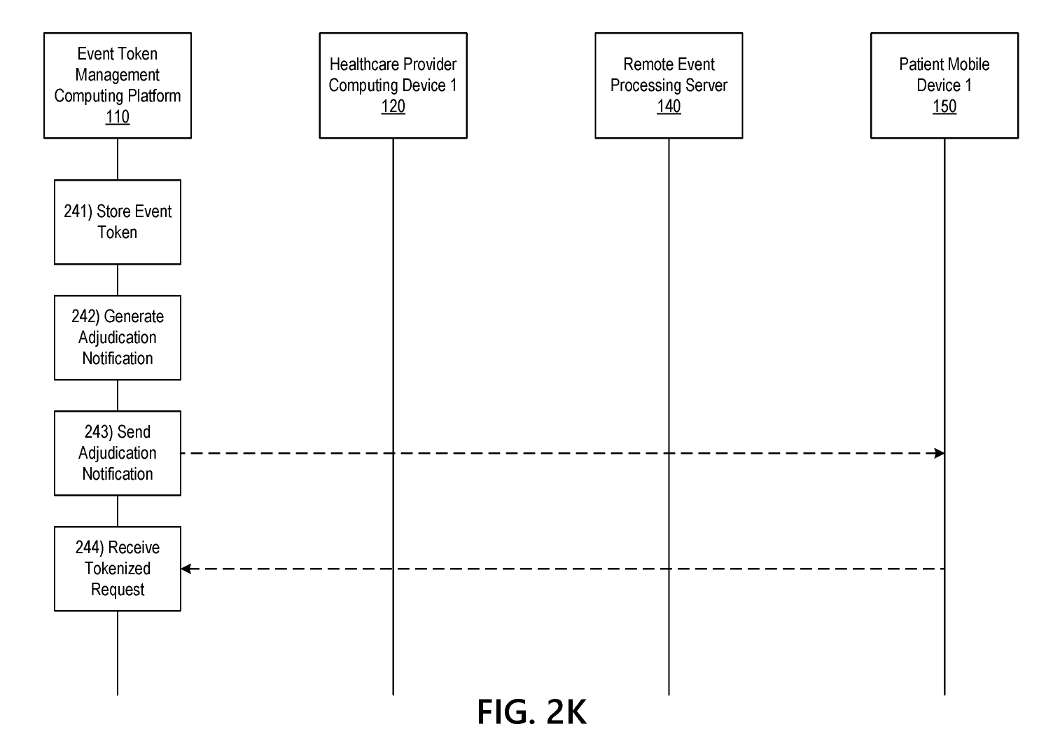

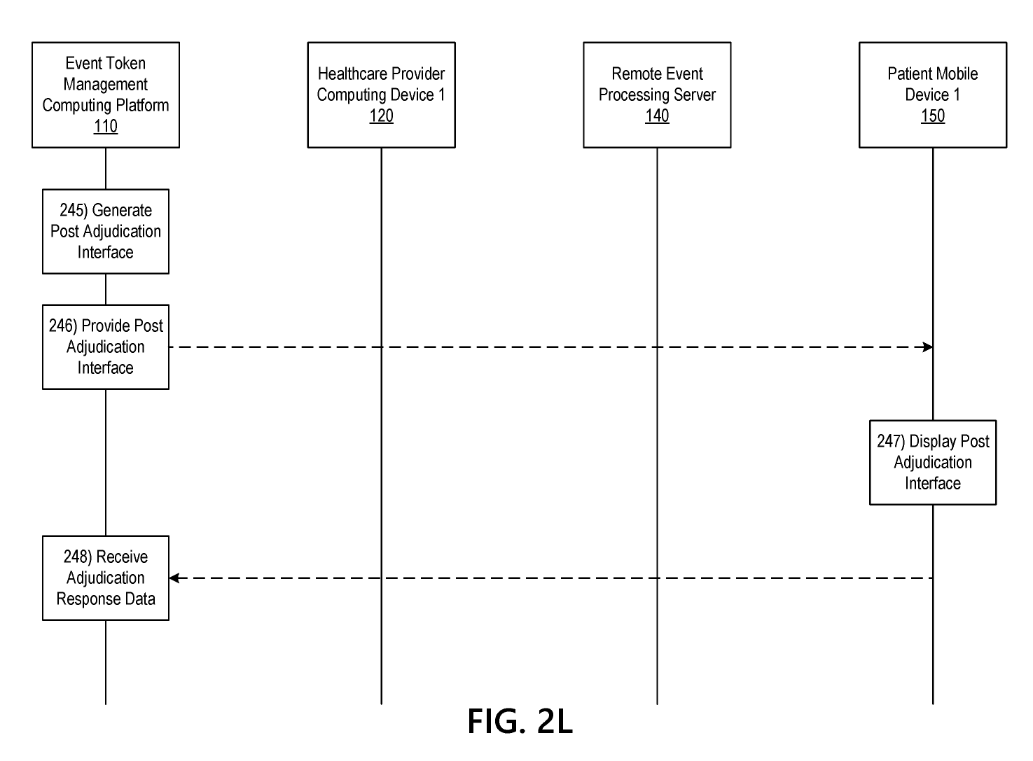

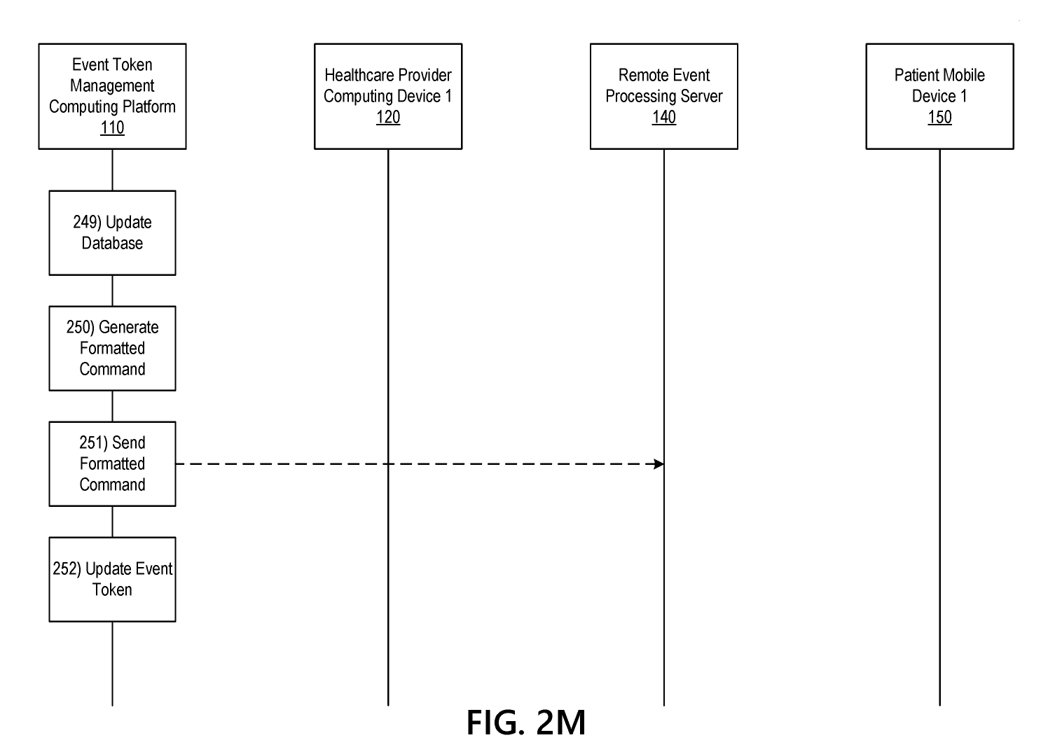

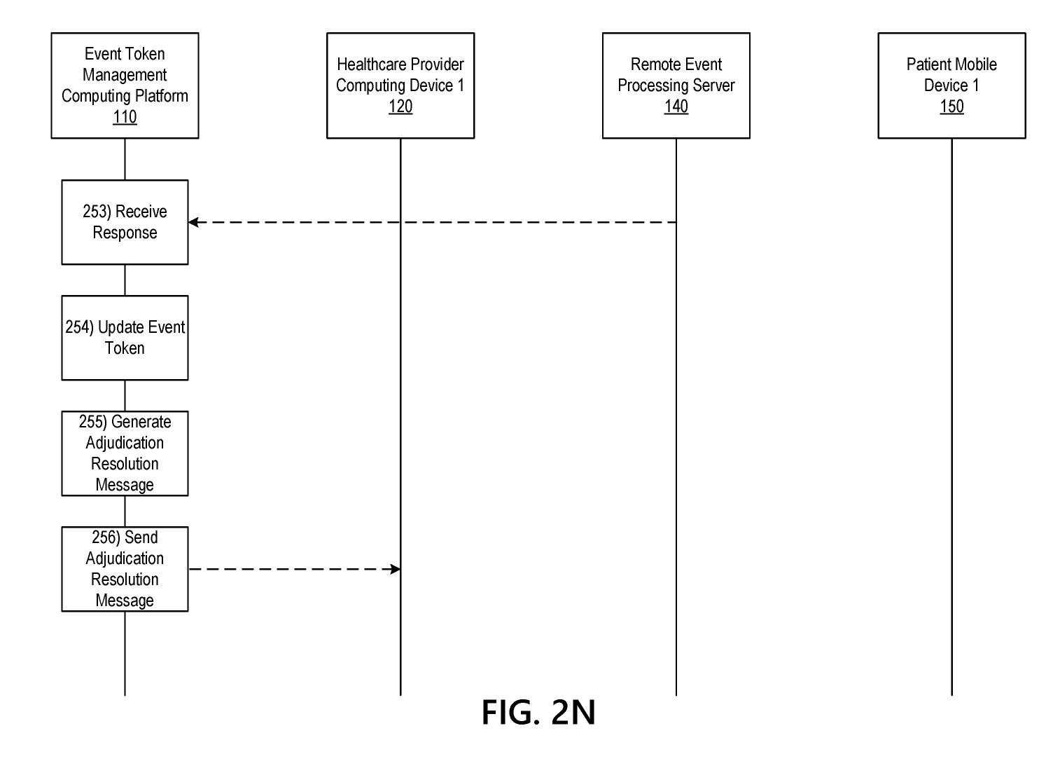

FIGS. 2A-2O depict an illustrative event sequence for using event tokens to track and control inter-system processing events associated with medical-related data in accordance with one or more example embodiments. Referring to FIG. 2A, at step 201, event token management computing platform 110 may generate a provider registration interface. For example, at step 201, event token management computing platform 110 may generate a provider registration interface based on one or more stored user interface templates, responsive to a request received by event token management computing platform 110 from one or more healthcare provider computing devices (e.g., healthcare provider computing device 120, healthcare provider computing device 130) and/or based on one or more administrator commands and/or configuration settings.

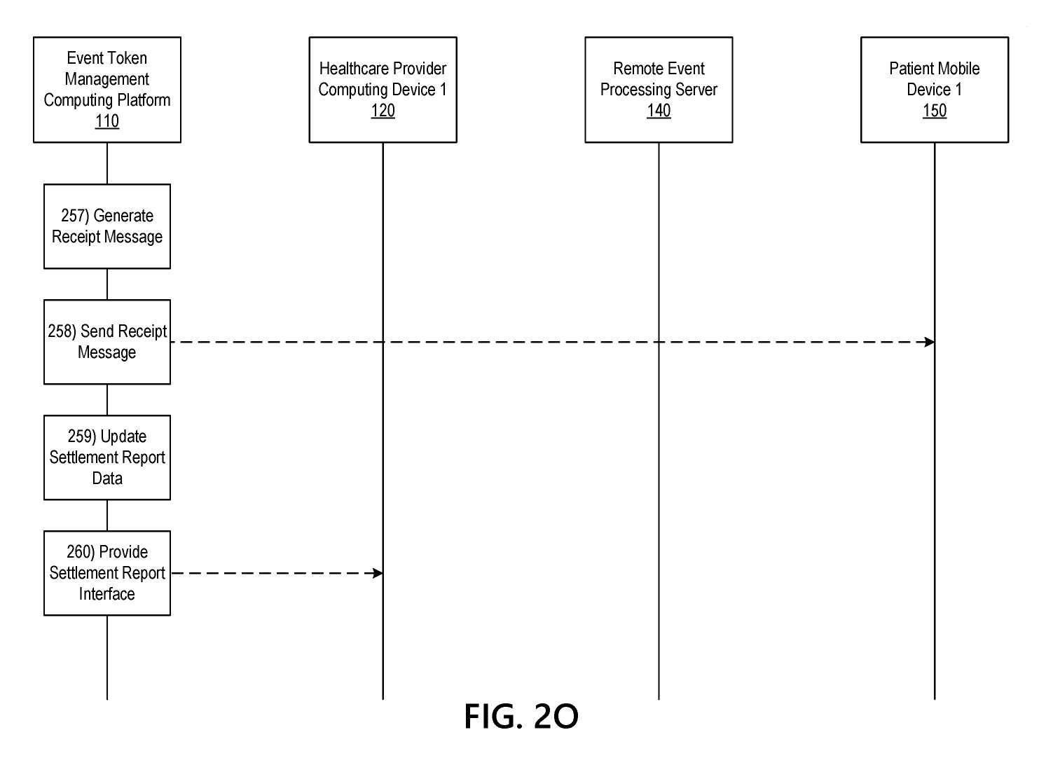

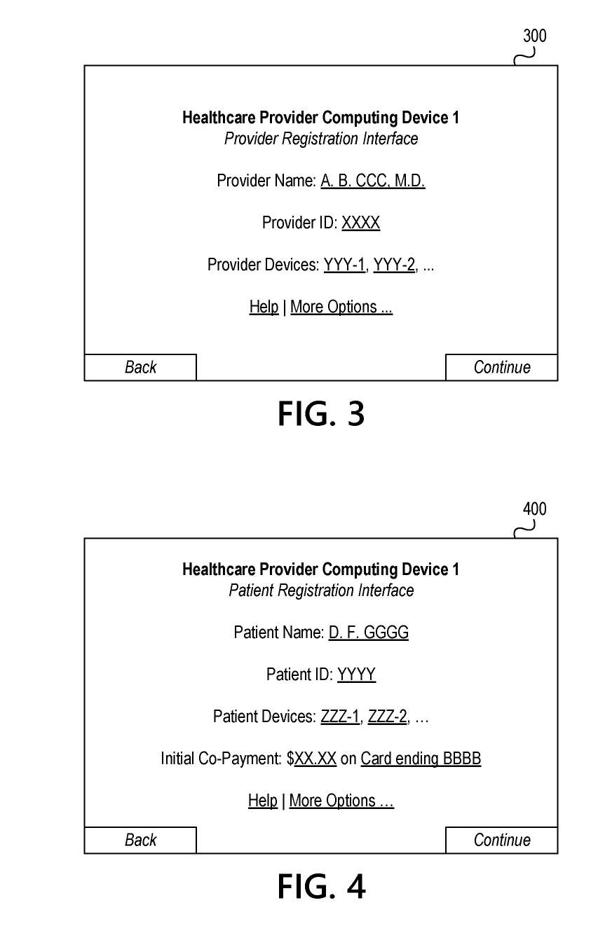

At step 202, event token management computing platform 110 may provide the provider registration interface to healthcare provider computing device 120. For example, at step 202, event token management computing platform 110 may send, transmit, and/or otherwise provide the provider registration interface to healthcare provider computing device 120, which may cause healthcare provider computing device 120 to display and/or otherwise present the provider registration interface generated by event token management computing platform 110. For instance, in providing the provider registration interface to healthcare provider computing device 120, event token management computing platform 110 may cause healthcare provider computing device 120 to display and/or otherwise present a graphical user interface similar to graphical user interface 300, which is illustrated in FIG. 3. As seen in FIG. 3, graphical user interface 300 may include one or more fields and/or controls enabling a user of healthcare provider computing device 120 to enter and/or select a provider name for a healthcare provider to be registered with event token management computing platform 110, enter and/or select a provider identifier for the healthcare provider to be registered with event token management computing platform 110, enter and/or select one or more provider devices linked to the healthcare provider to be registered with event token management computing platform 110, and/or define one or more other parameters and/or preferences for the healthcare provider to be registered with event token management computing platform 110.

At step 203, healthcare provider computing device 120 may receive provider registration input. For example, at step 203, healthcare provider computing device 120 may receive provider registration input from a user of healthcare provider computing device 120 via the provider registration interface displayed and/or presented by healthcare provider computing device 120 at step 202. At step 204, healthcare provider computing device 120 may send a provider registration request to event token management computing platform 110. For example, at step 204, healthcare provider computing device 120 may send a provider registration request to event token management computing platform 110 that includes any and/or all of the provider registration input received from the user of healthcare provider computing device 120 via the provider registration interface displayed and/or presented by healthcare provider computing device 120 and/or other information generated by healthcare provider computing device 120 based on the provider registration input received from the user of healthcare provider computing device 120 via the provider registration interface displayed and/or presented by healthcare provider computing device 120.

Referring to FIG. 2B, at step 205, event token management computing platform 110 may receive a provider registration request. For example, at step 205, event token management computing platform 110 may receive the provider registration request sent by healthcare provider computing device 120. At step 206, event token management computing platform 110 may generate a provider profile. For example, at step 206, event token management computing platform 110 may generate a provider profile based on the provider registration request received from healthcare provider computing device 120 by creating a data structure based on data included in the provider registration request received from healthcare provider computing device 120 that can be stored in one or more databases (e.g., event token management database 112b) and/or otherwise used by event token management computing platform 110. At step 207, event token management computing platform 110 may update one or more databases (e.g., event token management database 112b) based on the provider registration request received from healthcare provider computing device 120 and/or based on the provider profile generated from the provider registration request. For example, at step 207, event token management computing platform 110 may update one or more databases (e.g., event token management database 112b) to add one or more provider-specific fields and/or codes to the one or more databases (e.g., event token management database 112b) for the newly added provider associated with the provider profile generated from the provider registration request.

At step 208, healthcare provider computing device 120 may receive input requesting to register a new patient. For example, at step 208, healthcare provider computing device 120 may receive input requesting to register a new patient with event token management computing platform 110 from a user of healthcare provider computing device 120 (e.g., via one or more graphical user interfaces presented by healthcare provider computing device 120).

Referring to FIG. 2C, at step 209, healthcare provider computing device 120 may send a new patient registration request to event token management computing platform 110 (e.g., in response to and/or otherwise based on the input received at step 208). At step 210, event token management computing platform 110 may receive the new patient registration request from healthcare provider computing device 120. At step 211, event token management computing platform 110 may generate a patient registration interface. For example, at step 211, event token management computing platform 110 may generate a patient registration interface based on one or more user interface templates stored by event token management computing platform 110 and/or based on the new patient registration request received from healthcare provider computing device 120. At step 212, event token management computing platform 110 may provide the patient registration interface to healthcare provider computing device 120. For example, at step 212, event token management computing platform 110 may send, transmit, and/or otherwise provide the patient registration interface to healthcare provider computing device 120, which may cause healthcare provider computing device 120 to display and/or otherwise present the patient registration interface generated by event token management computing platform 110. For instance, in providing the patient registration interface to healthcare provider computing device 120, event token management computing platform 110 may cause healthcare provider computing device 120 to display and/or otherwise present a graphical user interface similar to graphical user interface 400, which is illustrated in FIG. 4. As seen in FIG. 4, graphical user interface 400 may include one or more fields and/or controls enabling a user of healthcare provider computing device 120 to enter and/or select a patient name for a patient to be registered with event token management computing platform 110, enter and/or select a patient identifier for the patient to be registered with event token management computing platform 110, enter and/or select one or more patient devices linked to the patient to be registered with event token management computing platform 110, define an initial co-payment amount for the patient to be registered with event token management computing platform 110, define a payment card or other stored payment method (which may, e.g., be used for payment of the initial co-payment amount and/or future payments) for the patient to be registered with event token management computing platform 110, and/or define one or more other parameters and/or preferences for the patient to be registered with event token management computing platform 110.

Referring to FIG. 2D, at step 213, healthcare provider computing device 120 may receive patient registration input. For example, at step 213, healthcare provider computing device 120 may receive patient registration input from a user of healthcare provider computing device 120 via the patient registration interface displayed and/or presented by healthcare provider computing device 120 at step 212. At step 214, healthcare provider computing device 120 may send patient registration data to event token management computing platform 110. For example, at step 214, healthcare provider computing device 120 may send patient registration data to event token management computing platform 110 that includes any and/or all of the patient registration input received from the user of healthcare provider computing device 120 via the patient registration interface displayed and/or presented by healthcare provider computing device 120 and/or other information generated by healthcare provider computing device 120 based on the patient registration input received from the user of healthcare provider computing device 120 via the patient registration interface displayed and/or presented by healthcare provider computing device 120.

At step 215, event token management computing platform 110 may receive patient registration data. For example, at step 215, event token management computing platform 110 may receive, via a communication interface (e.g., communication interface(s) 113), from a healthcare provider computing device (e.g., healthcare provider computing device 120), patient registration data associated with a first patient. For instance, event token management computing platform 110 may receive the patient registration data sent by healthcare provider computing device 120. In some instances, the patient registration data received by event token management computing platform 110 (e.g., from healthcare provider computing device 120) may include payment information to be stored by event token management computing platform 110, such as a credit card number or debit card number, along with other card details (e.g., expiration date, security code, etc.), of the patient to be stored by event token management computing platform 110 as a stored payment method for the patient. Additionally or alternatively, the patient registration data received by event token management computing platform 110 (e.g., from healthcare provider computing device 120) may include one or more flags or other information indicating the patient's consent to the provider and/or event token management computing platform 110 storing the patient's payment information and charging the patient's stored payment information for current and/or future balances incurred in connection with healthcare services provided by the healthcare provider associated with healthcare provider computing device 120, such as initial co-payment(s) that may be due at the present and/or post-adjudication payments that may be due in the future.

At step 216, event token management computing platform 110 may generate a patient profile. For example, at step 216, event token management computing platform 110 may generate a patient profile for the first patient based on the patient registration data received from the healthcare provider computing device (e.g., healthcare provider computing device 120). For instance, at step 216, event token management computing platform 110 may generate a patient profile based on the patient registration data received from healthcare provider computing device 120 by creating a data structure based on the patient registration data received from healthcare provider computing device 120 that can be stored in one or more databases (e.g., event token management database 112b) and/or otherwise used by event token management computing platform 110.

Referring to FIG. 2E, at step 217, event token management computing platform 110 may update one or more databases (e.g., event token management database 112b) based on the patient registration data received from healthcare provider computing device 120 and/or based on the patient profile generated from the patient registration data. For example, at step 217, event token management computing platform 110 may update one or more databases (e.g., event token management database 112b) to add one or more patient-specific fields and/or codes to the one or more databases (e.g., event token management database 112b) for the newly added patient associated with the patient profile generated from the patient registration data.

At step 218, event token management computing platform 110 may identify, in the patient registration data received from healthcare provider computing device 120, data indicating an initial co-payment event to be processed. For example, at step 218, after generating the patient profile for the first patient, event token management computing platform 110 may identify data requesting an initial event in the patient registration data received from the healthcare provider computing device (e.g., healthcare provider computing device 120). Subsequently, event token management computing platform 110 may process the initial event by generating and sending one or more formatted commands to a remote event processing server (e.g., remote event processing server 140). For example, event token management computing platform 110 may process the initial co-payment event by generating and sending one or more formatted commands to remote event processing server 140 (e.g., to cause the initial co-payment amount to be charged to the patient's stored payment method), as discussed in greater detail with respect to the following steps below.

At step 219, event token management computing platform 110 may generate an event token. For example, at step 219, event token management computing platform 110 may generate an event token for the initial event (e.g., the initial co-payment event) identified by event token management computing platform 110 in the patient registration data received from healthcare provider computing device 120. In one or more arrangements, the event token generated by event token management computing platform 110 may be a unique identifier for the event (e.g., the initial co-payment event identified by event token management computing platform 110 in this instance) that uniquely links data associated with the event with a specific patient and a specific healthcare provider in one or more databases maintained by event token management computing platform 110 (e.g., event token management database 112b) and/or in one or more resources used by other computer systems or computing devices in computing environment 100. In some instances, the event token may be or include a unique alphanumeric string that is generated by event token management computing platform 110 by executing and/or otherwise using a random number generation algorithm or random character generation algorithm.

At step 220, event token management computing platform 110 may store the event token. For example, at step 220, event token management computing platform 110 may store the event token generated at step 219 in one or more databases maintained by event token management computing platform 110 (e.g., event token management database 112b). By storing the event token in one or more databases maintained by event token management computing platform 110 (e.g., event token management database 112b), event token management computing platform 110 may enable one or more devices (e.g., healthcare provider computing device 120, remote event processing server 140, patient mobile device 150) and/or one or more users of such devices to check the status of the event associated with the event token (e.g., the initial co-payment event in this instance) by submitting a query to event token management computing platform 110 with the unique identifier from the event token.

Referring to FIG. 2F, at step 221, event token management computing platform 110 may generate a formatted command (e.g., based on identifying the initial co-payment event to be processed, to initiate a process by which the initial co-payment amount to be charged to the patient's stored payment method). For example, at step 221, event token management computing platform 110 may generate a formatted command by dynamically generating a web API call to remote event processing server 140, which may direct remote event processing server 140 to charge the initial co-payment amount to the patient's stored payment method and/or otherwise process the payment associated with the initial co-payment event. At step 222, event token management computing platform 110 may send the formatted command to remote event processing server 140 (which may, e.g., direct and/or otherwise cause remote event processing server 140 to charge the initial co-payment amount to the patient's stored payment method and/or otherwise process the payment associated with the initial co-payment event). At step 223, event token management computing platform 110 may update the event token (e.g., the event token generated for the initial co-payment event above). For example, at step 223, event token management computing platform 110 may update the event token by updating one or more data records associated with the event token in one or more databases (e.g., event token management database 112b) to indicate that the formatted command has been sent to remote event processing server 140 and/or that the payment associated with the initial co-payment event is pending.

At step 224, event token management computing platform 110 may receive a response from remote event processing server 140. For example, at step 224, event token management computing platform 110 may receive a response from remote event processing server 140 acknowledging receipt of the formatted command sent by event token management computing platform 110, confirming that the formatted command sent by event token management computing platform 110 is being or has been executed, and/or indicating that the amount specified in the formatted command is being or has been charged to the payment method specified in the formatted command.

Referring to FIG. 2G, at step 225, event token management computing platform 110 may update the event token (e.g., the event token generated for the initial co-payment event above, based on the response received from remote event processing server 140). For example, at step 225, event token management computing platform 110 may update the event token by updating one or more data records associated with the event token in one or more databases (e.g., event token management database 112b) to indicate that the formatted command has been executed by remote event processing server 140 and/or that the payment amount associated with the initial co-payment event has been charged to the patient's stored payment method and/or completed.

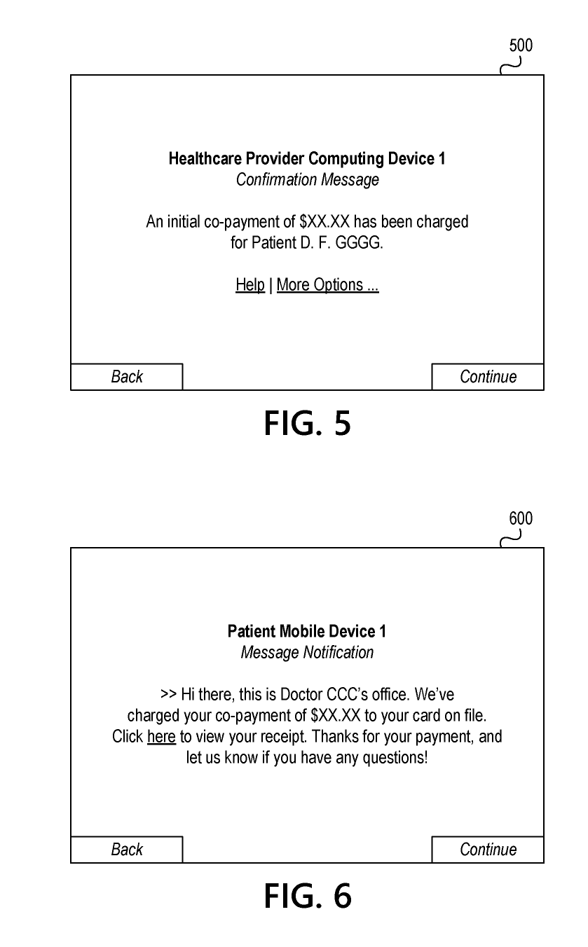

At step 226, event token management computing platform 110 may generate a confirmation message. For example, at step 226, event token management computing platform 110 may generate a confirmation message for healthcare provider computing device 120 indicating that the formatted command sent by event token management computing platform 110 to remote event processing server 140 has been executed by remote event processing server 140 and/or that the payment amount associated with the initial co-payment event has been charged to the patient's stored payment method and/or completed. At step 227, event token management computing platform 110 may send the confirmation message to healthcare provider computing device 120. For example, at step 227, event token management computing platform 110 may send, transmit, and/or otherwise communicate the confirmation message to healthcare provider computing device 120, which may cause healthcare provider computing device 120 to display and/or otherwise present the confirmation message generated by event token management computing platform 110. For instance, in sending the confirmation message to healthcare provider computing device 120, event token management computing platform 110 may cause healthcare provider computing device 120 to display and/or otherwise present a graphical user interface similar to graphical user interface 500, which is illustrated in FIG. 5. As seen in FIG. 5, graphical user interface 500 may include text content and/or information indicating that the initial co-payment has been charged for a specific patient, as well as one or more fields and/or controls enabling a user of healthcare provider computing device 120 to view and/or modify other parameters associated with the initial co-payment for the specific patient and/or other preferences for the specific patient.

At step 228, event token management computing platform 110 may generate a receipt message. For example, at step 228, event token management computing platform 110 may generate a receipt message for patient mobile device 150 indicating that the payment amount associated with the initial co-payment event has been charged to the patient's stored payment method and/or completed. In generating the receipt message, event token management computing platform 110 may insert, into the receipt message, a tokenized link that is user-selectable to enable a recipient of the receipt message to access and/or view receipt information associated with the charges and/or completion of the co-payment event. In addition, the tokenized link may include the event token associated with the initial co-payment event (e.g., the unique identifier associated with the initial co-payment event may be embedded in the uniform resource locator referenced in the tokenized link), so that when a recipient user invokes the tokenized link on patient mobile device 150 and event token management computing platform 110 receives a request for content associated with the tokenized link from patient mobile device 150, event token management computing platform 110 may provide immediate and direct access to the receipt information associated with the charges and/or completion of the co-payment event, without prompting or requiring the user of patient mobile device 150 to login or otherwise authenticate with event token management computing platform 110. In this way, the tokenized link included in the receipt message may provide a deep-linking functionality to a patient user of patient mobile device 150 that enables the patient to quickly and securely access the receipt information associated with the charges and/or completion of the co-payment event.

Referring to FIG. 2H, at step 229, event token management computing platform 110 may send a receipt message to patient mobile device 150. For example, at step 229, event token management computing platform 110 may send to patient mobile device 150 the receipt message generated at step 228 that includes the tokenized link associated with the event token linked to the initial co-payment event. For instance, at step 229, event token management computing platform 110 may send, transmit, and/or otherwise communicate the receipt message to patient mobile device 150, which may cause patient mobile device 150 to display and/or otherwise present the receipt message generated by event token management computing platform 110. In some instances, event token management computing platform 110 may send the receipt message to patient mobile device 150 as a Short Messaging Service (SMS) message via a text messaging service or as a push notification via a push notification service. Additionally or alternatively, in sending the receipt message to patient mobile device 150, event token management computing platform 110 may cause patient mobile device 150 to display and/or otherwise present a graphical user interface similar to graphical user interface 600, which is illustrated in FIG. 6. As seen in FIG. 6, graphical user interface 600 may include text content and/or information indicating that the initial co-payment has been charged (e.g., “Hi there, this is Doctor CCC's office. We've charged your co-payment of $XX.XX to your card on file.”), as well as a tokenized link (e.g., “Click here to view your receipt.”) that may be selected and/or otherwise invoked by the user of patient mobile device 150 to request and subsequently access from event token management computing platform 110 receipt information associated with the charges and/or completion of the co-payment event. For example, if and when the user of patient mobile device 150 selects the tokenized link, patient mobile device 150 may request the content referenced by the link from event token management computing platform 110. Then, in response to receiving such a request (which, e.g., would include the event token associated with the co-payment event in this example), event token management computing platform 110 may generate and provide one or more user interfaces that include receipt information associated with the charges and/or completion of the co-payment event to patient mobile device 150.

Subsequently, in this example event sequence, after the initial co-payment event is processed, an office visit or other patient encounter may be completed in which the patient may see a healthcare provider for treatment and/or other services. Subsequently, the healthcare provider may submit an insurance claim with the patient's health insurance provider, which may perform an adjudication process in which a portion of the claimed amount may be identified as covered and thus paid to the healthcare provider while a remainder of the claimed amount may be identified as patient responsibility. The health insurance provider may notify the healthcare provider as to the outcome of the adjudication process (e.g., via email, paper mail, facsimile, etc.) and may pay the healthcare provider for the covered portion of the claimed amount. Subsequently, the healthcare provider may bill the patient for the remainder of the claimed amount that was identified as being the patient's responsibility. One or more of the following steps of the example event sequence discussed in greater detail below illustrate how a healthcare provider user may utilize healthcare provider computing device 120 and/or event token management computing platform 110 to enter information associated with the outcome of the claim adjudication process and initiate billing of the patient for any amount that may have been identified as patient responsibility. In addition, one or more of the following steps of the example event sequence discussed in greater detail below illustrate how the patient may be automatically and electronically billed for such amounts using the patient's stored payment information and various event tokens. Additionally, one or more of the following steps of the example event sequence discussed in greater detail below illustrate how, in some instances, the adjudication and payment process may be accelerated through use of a self-learning adjudication bot that may automatically adjudicate the health insurance claim and bypass a health insurance company's traditional adjudication process to identify an amount owed by the patient after an office visit or other patient encounter. For example, the self-learning adjudication bot may maintain a database of insurance contracts and may predict the outcome of the adjudication process (and thus initiate expedited billing and/or processing of the medical insurance claim) based on this database of insurance contracts and other historical usage information collected and iteratively enhanced by the self-learning adjudication bot during the course of its operation or another period of time.

Referring again to FIG. 2H, at step 230, healthcare provider computing device 120 may receive a request to enter adjudication input (e.g., from a user of healthcare provider computing device 120 after adjudication results information is received from a health insurance provider in connection with one or more patient encounters). At step 231, healthcare provider computing device 120 may send a request for an adjudication user interface to event token management computing platform 110 (e.g., based on the request to enter adjudication input received from the user of healthcare provider computing device 120). At step 232, event token management computing platform 110 may receive the request for an adjudication user interface from healthcare provider computing device 120.

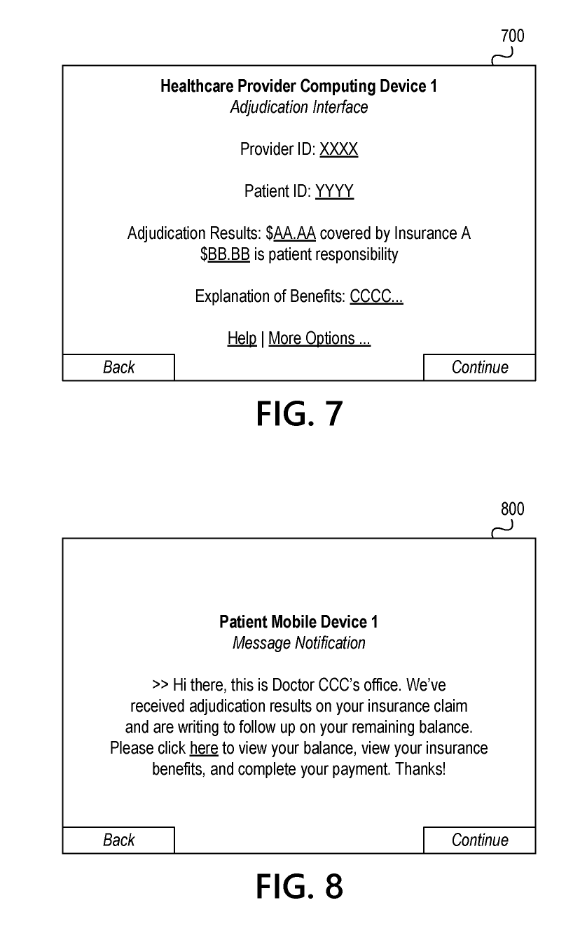

Referring to FIG. 2I, at step 233, event token management computing platform 110 may generate an adjudication interface based on one or more stored user interface templates, responsive to the request received by event token management computing platform 110 from healthcare provider computing device 120. At step 234, event token management computing platform 110 may provide the adjudication interface to healthcare provider computing device 120. For example, at step 234, event token management computing platform 110 may send, transmit, and/or otherwise provide the adjudication interface to healthcare provider computing device 120, which may cause healthcare provider computing device 120 to display and/or otherwise present the adjudication interface generated by event token management computing platform 110. For instance, in providing the adjudication interface to healthcare provider computing device 120, event token management computing platform 110 may cause healthcare provider computing device 120 to display and/or otherwise present a graphical user interface similar to graphical user interface 700, which is illustrated in FIG. 7. As seen in FIG. 7, graphical user interface 700 may include one or more fields and/or controls enabling a user of healthcare provider computing device 120 to enter and/or select a provider identifier associated with the healthcare provider using healthcare provider computing device 120, enter and/or select a patient identifier associated with adjudication data to be input, enter and/or select adjudication results information (which may, e.g., include a covered amount, a patient-responsibility amount, and an explanation of benefits) associated with a particular patient and/or a particular medical insurance claim associated with a particular encounter, and/or define one or more other parameters and/or preferences for the patient and/or the healthcare provider.

At step 235, healthcare provider computing device 120 may receive adjudication input. For example, at step 235, healthcare provider computing device 120 may receive adjudication input from a user of healthcare provider computing device 120 via the adjudication interface displayed and/or presented by healthcare provider computing device 120 at step 234. At step 236, healthcare provider computing device 120 may send adjudication data to event token management computing platform 110. For example, at step 236, healthcare provider computing device 120 may send adjudication data to event token management computing platform 110 that includes any and/or all of the adjudication input received from the user of healthcare provider computing device 120 via the adjudication interface displayed and/or presented by healthcare provider computing device 120 and/or other information generated by healthcare provider computing device 120 based on the adjudication input received from the user of healthcare provider computing device 120 via the adjudication interface displayed and/or presented by healthcare provider computing device 120.

Referring to FIG. 2J, at step 237, event token management computing platform 110 may receive adjudication data. For example, at step 237, event token management computing platform 110 may receive adjudication information comprising a patient identifier, a visit identifier, and adjudication results data. The patient identifier may, for instance, include information uniquely identifying a specific patient of a healthcare provider, such as the patient's name, unique identification number, and/or other identifying information. In addition, the visit identifier may, for instance, include information uniquely identifying a specific visit (e.g., a particular appointment on a particular date and time) by the identified patient to the identified healthcare provider. The adjudication results data may, for instance, include information identifying an amount of medical expenses that are covered and paid for by the patient's healthcare insurance, information identifying an amount of medical expenses that are not covered by the patient's healthcare insurance and remain the patient's responsibility to pay to the healthcare provider, and/or information identifying an explanation of the patient's benefits (e.g., explaining why certain expenses were covered or not covered, identifying certain discounts that might have been applied, etc.).

In some arrangements, in receiving adjudication data at step 237, event token management computing platform 110 may receive adjudication data from healthcare provider computing device 120. For instance, in some embodiments, receiving the adjudication information may include receiving the adjudication information from a healthcare provider computing device via the communication interface. For example, in receiving the adjudication information, event token management computing platform 110 may receive the adjudication information from a healthcare provider computing device (e.g., healthcare provider computing device 120) via a communication interface (e.g., communication interface(s) 113). For instance, in receiving adjudication data at step 237, event token management computing platform 110 may receive the adjudication data sent by healthcare provider computing device 120 to event token management computing platform 110 at step 236.

In additional or alternative arrangements, event token management computing platform 110 may receive adjudication data from a machine-learning-enabled adjudication engine provided by adjudication bot module 112c. For instance, in some embodiments, receiving the adjudication information may include receiving the adjudication information from an adjudication bot. For example, in receiving the adjudication information, event token management computing platform 110 may receive the adjudication information from an adjudication bot (which may, e.g., be provided by adjudication bot module 112c executing on event token management computing platform 110). For instance, event token management computing platform 110 may provide the patient information and/or the visit information to adjudication bot module 112c, which may analyze the patient information and/or the visit information based on insurance coverage information, historical adjudication results information, and/or other information to predict and return the adjudication results information to event token management computing platform 110 that can be used in billing the patient and bypassing the traditional health insurance claims adjudication process.

At step 238, event token management computing platform 110 may update one or more databases (e.g., event token management database 112b) based on the adjudication data received at step 237. For example, at step 238, event token management computing platform 110 may update one or more databases (e.g., event token management database 112b) to add any and/or all of the adjudication information received at step 237 (which may, e.g., include a patient identifier, a visit identifier, and adjudication results data associated with a specific patient) to the specific patient's profile stored in the one or more databases (e.g., event token management database 112b). At step 239, event token management computing platform 110 may identify, in the received adjudication information, data indicating an adjudication payment event to be processed. For example, at step 239, event token management computing platform 110 may identify, based on the received adjudication information, data indicating that a post-adjudication payment amount is due from the patient associated with the received adjudication information.

At step 240, event token management computing platform 110 may generate an event token (e.g., for the adjudication payment event identified in the received adjudication information). For example, at step 240, based on receiving the adjudication information, event token management computing platform 110 may generate an event token associated with a post-adjudication event, and the event token associated with the post-adjudication event may include a unique identifier linking the post-adjudication event to the patient identifier, the visit identifier, and the adjudication results data. As in the examples discussed above, the event token generated by event token management computing platform 110 may be a unique identifier for the event (e.g., the post-adjudication payment event identified by event token management computing platform 110 based on the received adjudication information in this instance) that uniquely links data associated with the event with a specific patient and a specific healthcare provider in one or more databases maintained by event token management computing platform 110 (e.g., event token management database 112b) and/or in one or more resources used by other computer systems or computing devices in computing environment 100. In some instances, the event token may be or include a unique alphanumeric string that is generated by event token management computing platform 110 by executing and/or otherwise using a random number generation algorithm or random character generation algorithm.

Referring to FIG. 2K, at step 241, event token management computing platform 110 may store the event token. For example, at step 241, event token management computing platform 110 may store the event token associated with the post-adjudication event in an event token database (e.g., event token management database 112b). By storing the event token in the event token database (e.g., event token management database 112b) or one or more other databases maintained by event token management computing platform 110, event token management computing platform 110 may enable one or more devices (e.g., healthcare provider computing device 120, remote event processing server 140, patient mobile device 150) and/or one or more users of such devices to check the status of the event associated with the event token (e.g., the post-adjudication payment event in this instance) by submitting a query to event token management computing platform 110 with the unique identifier from the event token.

At step 242, event token management computing platform 110 may generate an adjudication notification. For example, at step 242, event token management computing platform 110 may generate an adjudication notification for a patient mobile device (e.g., patient mobile device 150). In some embodiments, generating the adjudication notification for the patient mobile device may include accessing a patient profile linking the patient identifier with a device identifier corresponding to the patient mobile device to determine the device identifier corresponding to the patient mobile device. For example, in generating the adjudication notification for the patient mobile device (e.g., patient mobile device 150), event token management computing platform 110 may access a patient profile linking the patient identifier with a device identifier corresponding to the patient mobile device (e.g., patient mobile device 150) to determine the device identifier corresponding to the patient mobile device (e.g., patient mobile device 150). For instance, event token management computing platform 110 may access a patient profile stored in one or more databases maintained by event token management computing platform 110 (e.g., event token management database 112b). In addition, event token management computing platform 110 may determine the device identifier corresponding to the patient mobile device (e.g., patient mobile device 150) to be or include a unique hardware identification number (e.g., an International Mobile Equipment Identity (IMEI) number, a subscriber identity module (SIM) number, etc.) or a registered mobile telephone number associated with the device based on the accessed patient profile.

In some embodiments, generating the adjudication notification for the patient mobile device may include inserting, in the adjudication notification, a tokenized link corresponding to the event token associated with the post-adjudication event stored in the event token database. For example, in generating the adjudication notification for the patient mobile device (e.g., patient mobile device 150), event token management computing platform 110 may insert, in the adjudication notification, a tokenized link corresponding to the event token associated with the post-adjudication event stored in the event token database (e.g., event token management database 112b). Similar to the examples of tokenized links discussed above, the tokenized link may be user-selectable to enable a recipient of the receipt message to access and/or view adjudication information associated with the post-adjudication event. In addition, the tokenized link may include the event token associated with the post-adjudication event (e.g., the unique identifier associated with the post-adjudication event may be embedded in the uniform resource locator referenced in the tokenized link), so that when a recipient user invokes the tokenized link on patient mobile device 150 and event token management computing platform 110 receives a request for content associated with the tokenized link from patient mobile device 150, event token management computing platform 110 may provide immediate and direct access to the adjudication information associated with the post-adjudication event, without prompting or requiring the user of patient mobile device 150 to login or otherwise authenticate with event token management computing platform 110. In this way, the tokenized link included in the adjudication notification may provide a deep-linking functionality to a patient user of patient mobile device 150 that enables the patient to quickly and securely access the adjudication information associated with the post-adjudication event, such as the amount of the post-adjudication payment that may be due, as illustrated in greater detail below.

At step 243, event token management computing platform 110 may send the adjudication notification to patient mobile device 150. For example, at step 243, event token management computing platform 110 may send, via the communication interface (e.g., communication interface(s) 113), to the patient mobile device (e.g., patient mobile device 150), the adjudication notification generated for the patient mobile device (e.g., patient mobile device 150). For instance, at step 243, event token management computing platform 110 may send, transmit, and/or otherwise communicate the adjudication notification to patient mobile device 150, which may cause patient mobile device 150 to display and/or otherwise present the adjudication notification generated by event token management computing platform 110. In some instances, in sending the adjudication notification to patient mobile device 150, event token management computing platform 110 may cause patient mobile device 150 to display and/or otherwise present a graphical user interface similar to graphical user interface 800, which is illustrated in FIG. 8. As seen in FIG. 8, graphical user interface 800 may include text content and/or information indicating that adjudication results information has been received (e.g., “Hi there, this is Doctor CCC's office. We've received adjudication results on your insurance claim and are writing to follow up on your remaining balance.”), as well as a tokenized link (e.g., “Please click here to view your balance, view your insurance benefits, and complete your payment.”) that may be selected and/or otherwise invoked by the user of patient mobile device 150 to request and subsequently access from event token management computing platform 110 one or more interfaces to view a post-adjudication balance, view insurance benefits information, and complete payment. For example, if and when the user of patient mobile device 150 selects the tokenized link, patient mobile device 150 may request the content referenced by the link from event token management computing platform 110. Then, in response to receiving such a request (which, e.g., would include the event token associated with the post-adjudication event in this example), event token management computing platform 110 may generate and provide one or more user interfaces that enable the user of patient mobile device 150 to view a post-adjudication balance, view insurance benefits information, and complete payment, as illustrated in greater detail below.

In some embodiments, sending the adjudication notification generated for the patient mobile device to the patient mobile device may include sending the adjudication notification to the patient mobile device via a push notification service associated with the patient mobile device. For example, in sending the adjudication notification generated for the patient mobile device (e.g., patient mobile device 150) to the patient mobile device (e.g., patient mobile device 150), event token management computing platform 110 may send the adjudication notification to the patient mobile device (e.g., patient mobile device 150) via a push notification service associated with the patient mobile device (e.g., patient mobile device 150). For instance, event token management computing platform 110 may send the adjudication notification to patient mobile device 150 via a push notification service provided by and/or otherwise associated with an operating system executed on patient mobile device 150.

In some embodiments, sending the adjudication notification generated for the patient mobile device to the patient mobile device may include sending the adjudication notification to the patient mobile device via one or more text messages. For example, in sending the adjudication notification generated for the patient mobile device (e.g., patient mobile device 150) to the patient mobile device (e.g., patient mobile device 150), event token management computing platform 110 may send the adjudication notification to the patient mobile device (e.g., patient mobile device 150) via one or more text messages. For instance, event token management computing platform 110 may send the adjudication notification to patient mobile device 150 as one or more SMS messages via a text messaging service.

At step 244, event token management computing platform 110 may receive a tokenized request from patient mobile device 150. For example, at step 244, event token management computing platform 110 may receive, via the communication interface (e.g., communication interface(s) 113), from the patient mobile device (e.g., patient mobile device 150), a tokenized request for a post-adjudication user interface associated with the post-adjudication event. Such a tokenized request may, for instance, be received as a result of the user of patient mobile device 150 selecting and/or otherwise invoking a tokenized link (which may, e.g., have been included in the adjudication notification sent to patient mobile device 150 and which may have included the event token linked to the post-adjudication event, as discussed above).

In some embodiments, receiving the tokenized request for the post-adjudication user interface associated with the post-adjudication event from the patient mobile device may include receiving request information identifying the event token associated with the post-adjudication event stored in the event token database. For example, in receiving the tokenized request for the post-adjudication user interface associated with the post-adjudication event from the patient mobile device (e.g., patient mobile device 150), event token management computing platform 110 may receive request information identifying the event token associated with the post-adjudication event stored in the event token database (e.g., event token management database 112b). For instance, the event token linked to the post-adjudication event may have been embedded as a reference in the tokenized link sent to patient mobile device 150 with the adjudication notification, as discussed above, and the same event token thus may be included (e.g., as an argument or parameter) in the tokenized request received at step 244 (which may, e.g., correspond to a request to access and/or view information associated with the same post-adjudication event).

Referring to FIG. 2L, at step 245, event token management computing platform 110 may generate a post-adjudication user interface. For example, at step 245, in response to receiving the tokenized request for the post-adjudication user interface associated with the post-adjudication event from the patient mobile device (e.g., patient mobile device 150), event token management computing platform 110 may generate the post-adjudication user interface associated with the post-adjudication event based on the patient identifier, the visit identifier, and the adjudication results data associated with the adjudication information. For example, event token management computing platform 110 may generate the post-adjudication user interface based on one or more stored user interface templates and based on medical account information and/or adjudication information associated with the specific patient, so as to cause patient mobile device 150 to display (and enable the patient user of patient mobile device 150 to view and interact with) information identifying an amount of medical expenses that are covered and paid for by the patient's healthcare insurance, information identifying an amount of medical expenses that are not covered by the patient's healthcare insurance and remain the patient's responsibility to pay to the healthcare provider, and/or information identifying an explanation of the patient's benefits (e.g., explaining why certain expenses were covered or not covered, identifying certain discounts that might have been applied, etc.). In addition, part or all of this information may include and/or be considered private and confidential medical-related data that must be maintained in compliance with various privacy laws, regulations, and rules, such as HIPAA, and using an event token to initiate generation of the post-adjudication user interface as described may enable and improve both data security and privacy compliance as well as computing infrastructure performance and resource consumption.

At step 246, event token management computing platform 110 may provide the post-adjudication user interface to patient mobile device 150. For example, at step 246, event token management computing platform 110 may send, via the communication interface (e.g., communication interface(s) 113), to the patient mobile device (e.g., patient mobile device 150), the post-adjudication user interface associated with the post-adjudication event. For instance, event token management computing platform 110 may establish a connection to patient mobile device 150 via communication interface(s) 113 and send the post-adjudication user interface associated with the post-adjudication event to patient mobile device 150 while the connection to patient mobile device 150 is established via communication interface(s) 113. In addition, in sending the post-adjudication user interface to patient mobile device 150, event token management computing platform 110 may cause patient mobile device 150 to display and/or otherwise present one or more graphical user interfaces, as discussed in greater detail below.

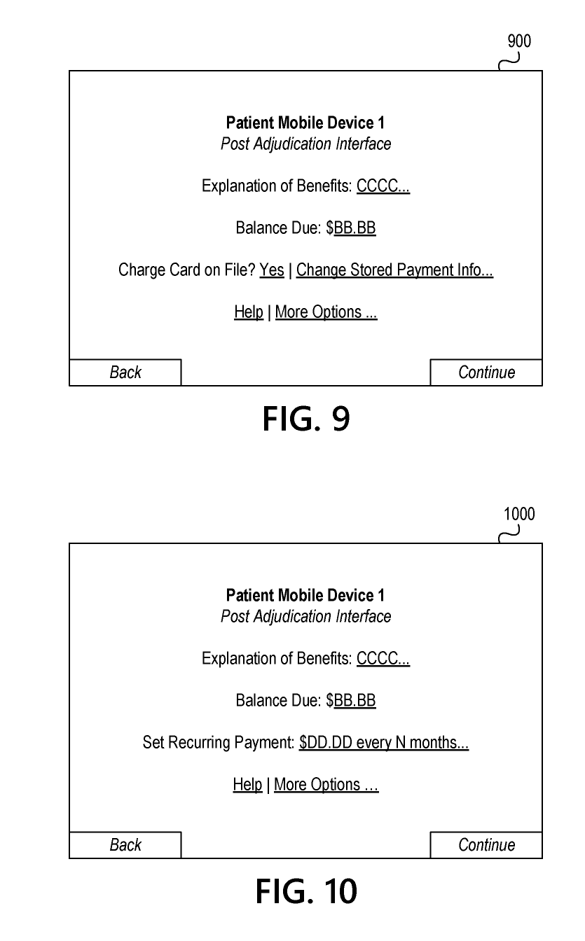

At step 247, patient mobile device 150 may display the post-adjudication user interface received from event token management computing platform 110. For example, in some instances, in displaying the post-adjudication user interface received from event token management computing platform 110, patient mobile device 150 may display and/or otherwise a graphical user interface similar to graphical user interface 900, which is illustrated in FIG. 9 and which provides an example where a patient is prompted to pay a post-adjudication balance. As seen in FIG. 9, graphical user interface 900 may include text content and/or information providing an explanation of the patient's insurance benefits, text content and/or information identifying a post-adjudication balance due from the patient to the healthcare provider, and one or more fields and/or controls prompting the user of patient mobile device 150 to charge a stored payment method or change the stored payment method to complete the payment.

As another example, in displaying the post-adjudication user interface received from event token management computing platform 110, patient mobile device 150 may display and/or otherwise a graphical user interface similar to graphical user interface 1000, which is illustrated in FIG. 10 and which provides an example where a patient is able to define a recurring payment to pay a post-adjudication balance. As seen in FIG. 10, graphical user interface 1000 may include text content and/or information providing an explanation of the patient's insurance benefits, text content and/or information identifying a post-adjudication balance due from the patient to the healthcare provider, and one or more fields and/or controls enabling the user of patient mobile device 150 to define a monthly recurring payment to resolve the post-adjudication balance due over a period of time.

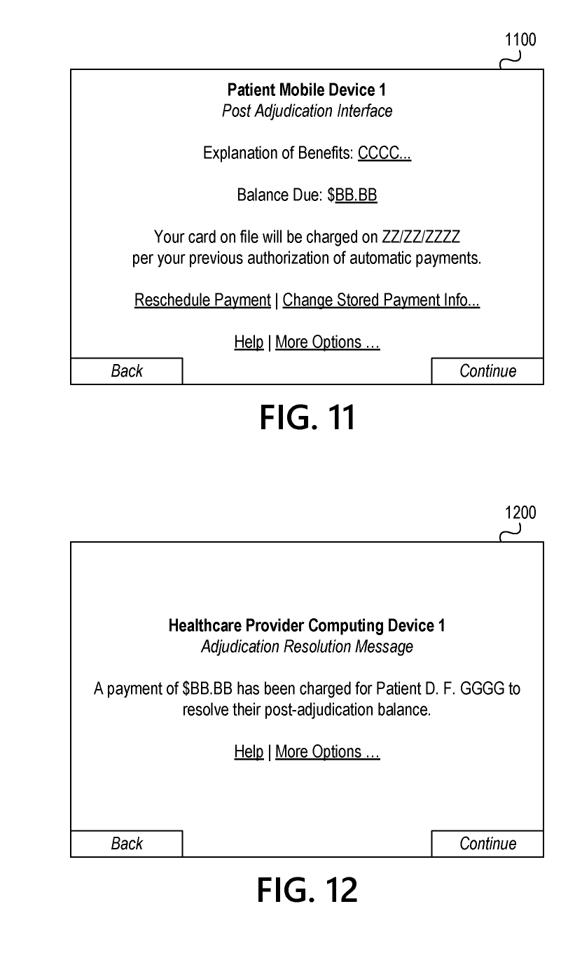

As another example, in displaying the post-adjudication user interface received from event token management computing platform 110, patient mobile device 150 may display and/or otherwise a graphical user interface similar to graphical user interface 1100, which is illustrated in FIG. 11 and which provides an example where a patient is notified that a stored payment method will be automatically charged to pay a post-adjudication balance. As seen in FIG. 11, graphical user interface 1100 may include text content and/or information providing an explanation of the patient's insurance benefits, text content and/or information identifying a post-adjudication balance due from the patient to the healthcare provider, text content and/or information notifying the patient that their stored payment method will be charged in accordance with the patient previously authorizing automatic payments on their stored payment method (which may, e.g., be stored in and/or otherwise reflected in the patient's profile maintained by event token management computing platform 110), and one or more fields and/or controls enabling the user of patient mobile device 150 to reschedule the automatic payment or change the stored payment method to complete the payment.

At step 248, event token management computing platform 110 may receive adjudication response data from patient mobile device 150. For example, at step 248, after sending the post-adjudication user interface associated with the post-adjudication event to the patient mobile device (e.g., patient mobile device 150), event token management computing platform 110 may receive, via the communication interface (e.g., communication interface(s) 113), from the patient mobile device (e.g., patient mobile device 150), post-adjudication response data associated with the post-adjudication event. The post-adjudication response data associated with the post-adjudication event may, for instance, include information indicating that the user of patient mobile device 150 has authorized the post-adjudication payment to proceed using their stored payment information, information indicating that the user of patient mobile device 150 has defined a recurring payment to complete the post-adjudication payment, information indicating that the user of patient mobile device 150 has requested to change their stored payment method, and/or other information.

In some embodiments, receiving the post-adjudication response data associated with the post-adjudication event from the patient mobile device may include receiving response data indicating patient authorization to complete the post-adjudication event. For example, in receiving the post-adjudication response data associated with the post-adjudication event from the patient mobile device (e.g., patient mobile device 150), event token management computing platform 110 may receive response data indicating patient authorization to complete the post-adjudication event. For instance, event token management computing platform 110 may receive response data indicating that the patient has authorized their stored payment method to be charged in the amount of their post-adjudication balance due.

In some embodiments, receiving the post-adjudication response data associated with the post-adjudication event from the patient mobile device may include receiving response data requesting a recurring event to complete the post-adjudication event. For example, in receiving the post-adjudication response data associated with the post-adjudication event from the patient mobile device (e.g., patient mobile device 150), event token management computing platform 110 may receive response data requesting a recurring event to complete the post-adjudication event. For instance, event token management computing platform 110 may receive response data defining a recurring payment to complete a post-adjudication payment, as in the examples discussed above.

In some embodiments, receiving the post-adjudication response data associated with the post-adjudication event from the patient mobile device may include receiving response data defining new patient profile information. For example, in receiving the post-adjudication response data associated with the post-adjudication event from the patient mobile device (e.g., patient mobile device 150), event token management computing platform 110 may receive response data defining new patient profile information. For instance, event token management computing platform 110 may receive response data defining a new stored payment method, a new card number, a new expiration date, and/or other new patient-specific profile information.

Referring to FIG. 2M, at step 249, event token management computing platform 110 may update one or more databases (e.g., event token management database 112b). For example, at step 249, event token management computing platform 110 may update one or more databases (e.g., event token management database 112b) based on the adjudication response data received at step 248. For instance, if the patient associated with patient mobile device 150 made any changes to their profile or stored payment information, or if the patient associated with patient mobile device 150 defined a recurring payment, event token management computing platform 110 may update one or more databases (e.g., event token management database 112b) to reflect such changes and/or configuration settings.

At step 250, event token management computing platform 110 may generate a formatted command. For example, at step 250, based on receiving the post-adjudication response data associated with the post-adjudication event, event token management computing platform 110 may generate a formatted command directing a remote event processing server (e.g., remote event processing server 140) to complete the post-adjudication event. Similar to the examples discussed above, event token management computing platform 110 may generate a formatted command by dynamically generating a web API call to remote event processing server 140, which may direct remote event processing server 140 to charge the post-adjudication payment amount to the patient's stored payment method and/or otherwise process the payment associated with the post-adjudication payment amount (e.g., in accordance with the adjudication response data received at step 248).

In some embodiments, generating the formatted command directing the remote event processing server to complete the post-adjudication event may include generating at least one command for the remote event processing server and formatting the at least one command for the remote event processing server in accordance with a web-based application programming interface (API) provided by the remote event processing server. For example, in generating the formatted command directing the remote event processing server (e.g., remote event processing server 140) to complete the post-adjudication event, event token management computing platform 110 may generate at least one command for the remote event processing server (e.g., remote event processing server 140) and format the at least one command for the remote event processing server (e.g., remote event processing server 140) in accordance with a web-based application programming interface (API) provided by the remote event processing server (e.g., remote event processing server 140). For instance, event token management computing platform 110 may generate and format a command that includes one or more web API calls that each utilize a web API, which may be exposed by remote event processing server 140 and which may have a defined set of functions and associated syntax for such functions, as discussed above.

In some embodiments, generating the formatted command directing the remote event processing server to complete the post-adjudication event may include configuring the formatted command to direct the remote event processing server to debit a payment account linked to a patient associated with the post-adjudication event. For example, in generating the formatted command directing the remote event processing server (e.g., remote event processing server 140) to complete the post-adjudication event, event token management computing platform 110 may configure the formatted command to direct the remote event processing server (e.g., remote event processing server 140) to debit a payment account linked to a patient associated with the post-adjudication event. For instance, in generating the formatted command, event token management computing platform 110 may access a patient profile linking the patient's patient identifier with the patient's stored payment information identifying a specific payment account to be debited.

At step 251, event token management computing platform 110 may send the formatted command to remote event processing server 140. For example, at step 251, event token management computing platform 110 may send, via the communication interface (e.g., communication interface(s) 113), to the remote event processing server (e.g., remote event processing server 140), the formatted command directing the remote event processing server (e.g., remote event processing server 140) to complete the post-adjudication event. For instance, event token management computing platform 110 may establish a connection to remote event processing server 140 via communication interface(s) 113 and send the formatted command directing remote event processing server 140 to complete the post-adjudication event while the connection to remote event processing server 140 is established via communication interface(s) 113.

At step 252, event token management computing platform 110 may update the event token (e.g., the event token generated for the post-adjudication event above). For example, at step 252, event token management computing platform 110 may update the event token by updating one or more data records associated with the event token in one or more databases (e.g., event token management database 112b) to indicate that the formatted command has been sent to remote event processing server 140 and/or that the payment associated with the post-adjudication payment event is pending.

Referring to FIG. 2N, at step 253, event token management computing platform 110 may receive a response from remote event processing server 140. For example, at step 253, event token management computing platform 110 may receive a response from remote event processing server 140 acknowledging receipt of the formatted command sent by event token management computing platform 110, confirming that the formatted command sent by event token management computing platform 110 is being or has been executed, and/or indicating that the amount specified in the formatted command is being or has been charged to the payment method specified in the formatted command.

At step 254, event token management computing platform 110 may update the event token (e.g., the event token generated for the post-adjudication event above, based on the response received from remote event processing server 140). For example, at step 254, event token management computing platform 110 may update the event token by updating one or more data records associated with the event token in one or more databases (e.g., event token management database 112b) to indicate that the formatted command has been executed by remote event processing server 140 and/or that the payment amount associated with the post-adjudication payment event has been charged to the patient's stored payment method and/or completed.

At step 255, event token management computing platform 110 may generate an adjudication resolution message. For example, at step 255, event token management computing platform 110 may generate an adjudication resolution message for healthcare provider computing device 120 indicating that the formatted command sent by event token management computing platform 110 to remote event processing server 140 has been executed by remote event processing server 140 and/or that the payment amount associated with the post-adjudication payment event has been charged to the patient's stored payment method and/or completed. At step 256, event token management computing platform 110 may send the adjudication resolution message to healthcare provider computing device 120. For example, at step 256, event token management computing platform 110 may send, transmit, and/or otherwise communicate the adjudication resolution message to healthcare provider computing device 120, which may cause healthcare provider computing device 120 to display and/or otherwise present the adjudication resolution message generated by event token management computing platform 110. For instance, in sending the adjudication resolution message to healthcare provider computing device 120, event token management computing platform 110 may cause healthcare provider computing device 120 to display and/or otherwise present a graphical user interface similar to graphical user interface 1200, which is illustrated in FIG. 12. As seen in FIG. 12, graphical user interface 1200 may include text content and/or information indicating that a post-adjudication payment has been charged for a specific patient, as well as one or more fields and/or controls enabling a user of healthcare provider computing device 120 to view and/or modify other parameters associated with the post-adjudication payment for the specific patient and/or other preferences for the specific patient.

Referring to FIG. 2O, at step 257, event token management computing platform 110 may generate a receipt message. For example, at step 257, event token management computing platform 110 may generate a receipt message for patient mobile device 150 indicating that the payment amount associated with the post-adjudication payment event has been charged to the patient's stored payment method and/or completed. In generating the receipt message, event token management computing platform 110 may insert, into the receipt message, a tokenized link that is user-selectable to enable a recipient of the receipt message to access and/or view receipt information associated with the charges and/or completion of the post-adjudication payment event. In addition, the tokenized link may include the event token associated with the post-adjudication event (e.g., the unique identifier associated with the post-adjudication event may be embedded in the uniform resource locator referenced in the tokenized link), so that when a recipient user invokes the tokenized link on patient mobile device 150 and event token management computing platform 110 receives a request for content associated with the tokenized link from patient mobile device 150, event token management computing platform 110 may provide immediate and direct access to the receipt information associated with the charges and/or completion of the post-adjudication event, without prompting or requiring the user of patient mobile device 150 to login or otherwise authenticate with event token management computing platform 110. In this way, the tokenized link included in the receipt message may provide a deep-linking functionality to a patient user of patient mobile device 150 that enables the patient to quickly and securely access the receipt information associated with the charges and/or completion of the post-adjudication event.

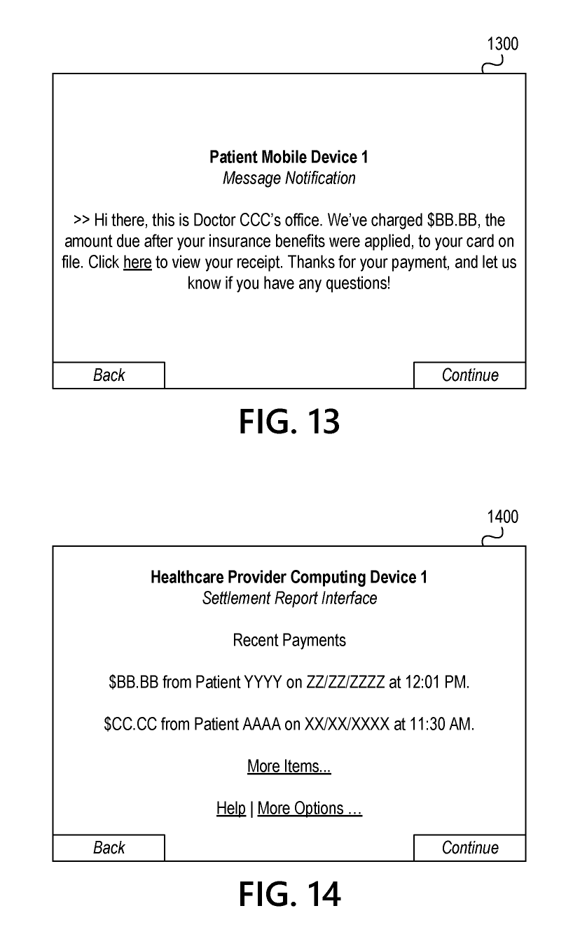

At step 258, event token management computing platform 110 may send a receipt message to patient mobile device 150. For example, at step 258, event token management computing platform 110 may send to patient mobile device 150 the receipt message generated at step 257 that includes the tokenized link associated with the event token linked to the post-adjudication event. For instance, at step 258, event token management computing platform 110 may send, transmit, and/or otherwise communicate the receipt message to patient mobile device 150, which may cause patient mobile device 150 to display and/or otherwise present the receipt message generated by event token management computing platform 110. In some instances, event token management computing platform 110 may send the receipt message to patient mobile device 150 as a Short Messaging Service (SMS) message via a text messaging service or as a push notification via a push notification service. Additionally or alternatively, in sending the receipt message to patient mobile device 150, event token management computing platform 110 may cause patient mobile device 150 to display and/or otherwise present a graphical user interface similar to graphical user interface 1300, which is illustrated in FIG. 13. As seen in FIG. 13, graphical user interface 1300 may include text content and/or information indicating that the post-adjudication payment has been charged (e.g., “Hi there, this is Doctor CCC's office. We've charged $BB.BB, the amount due after your insurance benefits were applied, to your card on file.”), as well as a tokenized link (e.g., “Click here to view your receipt.”) that may be selected and/or otherwise invoked by the user of patient mobile device 150 to request and subsequently access from event token management computing platform 110 receipt information associated with the charges and/or completion of the post-adjudication payment event. For example, if and when the user of patient mobile device 150 selects the tokenized link, patient mobile device 150 may request the content referenced by the link from event token management computing platform 110. Then, in response to receiving such a request (which, e.g., would include the event token associated with the post-adjudication event in this example), event token management computing platform 110 may generate and provide one or more user interfaces that include receipt information associated with the charges and/or completion of the post-adjudication payment event to patient mobile device 150.

At step 259, event token management computing platform 110 may update settlement report data. For example, at step 259, event token management computing platform 110 may update settlement report data for the healthcare provider associated with the post-adjudication payment event to reflect the monetary credit received by the healthcare provider as a result of the post-adjudication payment event. In some instances, event token management computing platform 110 may be configured to automatically transfer funds received on behalf of the healthcare provider to the healthcare provider on a periodic basis (e.g., weekly, monthly, etc.). At step 260, event token management computing platform 110 may provide one or more settlement report interfaces to healthcare provider computing device 120. For example, at step 260, event token management computing platform 110 may provide a settlement portal to healthcare provider computing device 120 in which information about recent payments and/or other events managed by event token management computing platform 110 for a healthcare provider may be presented. For instance, in providing the one or more settlement report interfaces to healthcare provider computing device 120, event token management computing platform 110 may cause healthcare provider computing device 120 to display and/or otherwise present a graphical user interface similar to graphical user interface 1400, which is illustrated in FIG. 14. As seen in FIG. 14, graphical user interface 1400 may include text and/or other information identifying one or more recent payments, as well as one or more fields and/or controls enabling a user of healthcare provider computing device 120 to modify various parameters and preferences associated with funds settlement (e.g., to settle funds between a payments platform and the healthcare provider's practice). In some instances, graphical user interface 1400 may be searchable, such that a user of healthcare provider computing device 120 may be able to search through various payment transactions listed in the settlement portal. In some instances, in addition to identifying payments, refunds and other types of transactions also may be reflected in the settlement portal. Additionally or alternatively, period batch reports may be provided by event token management computing platform 110 to various healthcare providers registered with event token management computing platform 110 (e.g., in email format, in spreadsheet format, etc.) concurrently with electronic funds transfers to facilitate settlement.

In some arrangements, rather than a patient user of patient mobile device 150 being present with an option to pay a balance due (e.g., a co-payment amount, a post-adjudication amount, etc.), a payment for such a balance may be automatically charged by event token management computing platform 110 in accordance with prior consent or other prior agreement provided by the patient user of patient mobile device 150. In these arrangements, such prior consent or other prior agreement may be reflected in information stored by event token management computing platform 110 in a patient profile for the particular patient (e.g., in event token management database 112b).

In some arrangements, for subsequent visits by the patient user of patient mobile device 150 to a doctor's office or clinic operated by the healthcare provider user of healthcare provider computing device 120, event token management computing platform 110 may send appointment reminders to patient mobile device 150 prior to such visits. In addition, the appointment reminders sent by event token management computing platform 110 to patient mobile device 150 may include tokenized links, referencing patient-specific user interfaces generated by event token management computing platform 110 for the user of patient mobile device 150, that enable the user of patient mobile device 150 to pay any needed co-payment amount prior to their appointment(s) or upon arrival at the doctor's office or clinic. Event token management computing platform 110 may provide such functionality using event tokens and formatted commands similar to how such event tokens and formatted commands are used in the examples discussed above.

In some arrangements, event token management computing platform 110 may provide healthcare provider computing device 120 with one or more user interfaces that enable healthcare provider computing device 120 to enter credit card numbers, debit card numbers, and other payment card numbers to process in-office payment transactions. Using such functionality, a user of healthcare provider computing device 120 may be able to enter a virtual card number into a user interface provided by event token management computing platform 110, so as to accept a payment from an insurance company (which may, e.g., typically pay a healthcare provider using a virtual card). In some instances, this functionality may enable a healthcare provider using healthcare provider computing device 120 to replace conventional point-of-sale terminals in their office with web-based user interfaces provided by event token management computing platform 110.

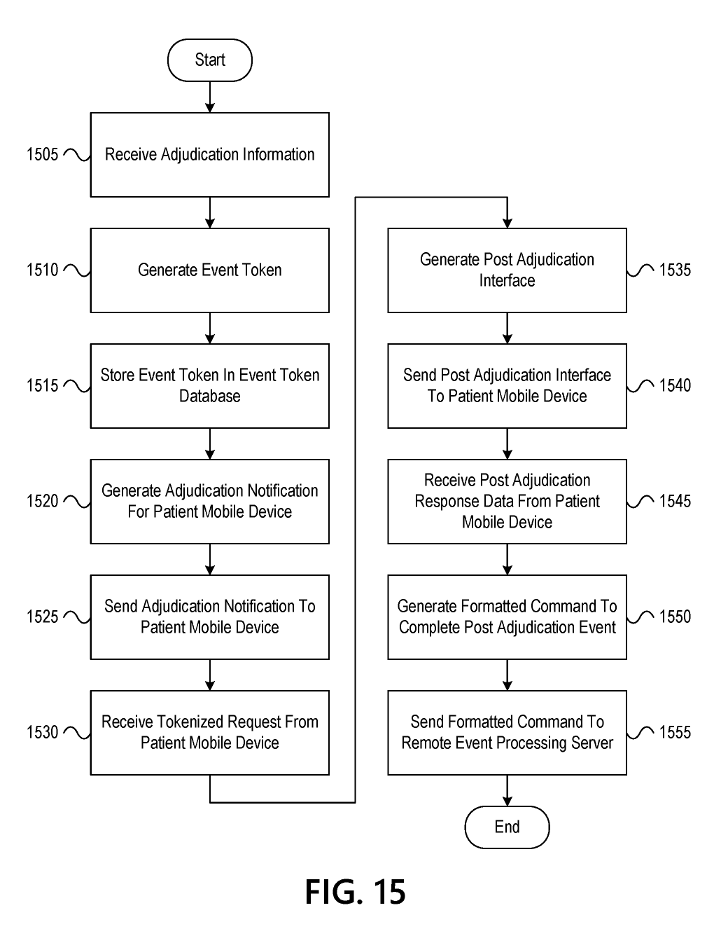

FIG. 15 depicts an illustrative method for using event tokens to track and control inter-system processing events associated with medical-related data in accordance with one or more example embodiments. Referring to FIG. 15, at step 1505, a computing platform having at least one processor, a communication interface, and memory may receive adjudication information comprising a patient identifier, a visit identifier, and adjudication results data. At step 1510, based on receiving the adjudication information, the computing platform may generate an event token associated with a post-adjudication event, and the event token associated with the post-adjudication event may include a unique identifier linking the post-adjudication event to the patient identifier, the visit identifier, and the adjudication results data. At step 1515, the computing platform may store the event token associated with the post-adjudication event in an event token database. At step 1520, the computing platform may generate an adjudication notification for a patient mobile device. At step 1525, the computing platform may send, via the communication interface, to the patient mobile device, the adjudication notification generated for the patient mobile device. At step 1530, the computing platform may receive, via the communication interface, from the patient mobile device, a tokenized request for a post-adjudication user interface associated with the post-adjudication event. At step 1535, in response to receiving the tokenized request for the post-adjudication user interface associated with the post-adjudication event from the patient mobile device, the computing platform may generate the post-adjudication user interface associated with the post-adjudication event based on the patient identifier, the visit identifier, and the adjudication results data associated with the adjudication information. At step 1540, the computing platform may send, via the communication interface, to the patient mobile device, the post-adjudication user interface associated with the post-adjudication event. At step 1545, after sending the post-adjudication user interface associated with the post-adjudication event to the patient mobile device, the computing platform may receive, via the communication interface, from the patient mobile device, post-adjudication response data associated with the post-adjudication event. At step 1550, based on receiving the post-adjudication response data associated with the post-adjudication event, the computing platform may generate a formatted command directing a remote event processing server to complete the post-adjudication event. At step 1555, the computing platform may send, via the communication interface, to the remote event processing server, the formatted command directing the remote event processing server to complete the post-adjudication event.

One or more aspects of the disclosure may be embodied in computer-usable data or computer-executable instructions, such as in one or more program modules, executed by one or more computers or other devices to perform the operations described herein. Program modules may include routines, programs, objects, components, data structures, and the like that perform particular tasks or implement particular data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media. The one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). In some instances, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive adjudication information comprising a patient identifier, a visit identifier, and adjudication results data;
based on receiving the adjudication information, generate an event token associated with a post-adjudication event, the event token associated with the post-adjudication event comprising a unique identifier linking the post-adjudication event to the patient identifier, the visit identifier, and the adjudication results data;
store the event token associated with the post-adjudication event in an event token database;
generate an adjudication notification for a patient mobile device;
send, via the communication interface, to the patient mobile device, the adjudication notification generated for the patient mobile device;
receive, via the communication interface, from the patient mobile device, a tokenized request for a post-adjudication user interface associated with the post-adjudication event;
in response to receiving the tokenized request for the post-adjudication user interface associated with the post-adjudication event from the patient mobile device, generate the post-adjudication user interface associated with the post-adjudication event based on the patient identifier, the visit identifier, and the adjudication results data associated with the adjudication information;
send, via the communication interface, to the patient mobile device, the post-adjudication user interface associated with the post-adjudication event;
after sending the post-adjudication user interface associated with the post-adjudication event to the patient mobile device, receive, via the communication interface, from the patient mobile device, post-adjudication response data associated with the post-adjudication event;
based on receiving the post-adjudication response data associated with the post-adjudication event, generate a formatted command directing a remote event processing server to complete the post-adjudication event; and
send, via the communication interface, to the remote event processing server, the formatted command directing the remote event processing server to complete the post-adjudication event.

2. The computing platform of claim 1, wherein receiving the adjudication information comprises receiving the adjudication information from a healthcare provider computing device via the communication interface.

3. The computing platform of claim 1, wherein receiving the adjudication information comprises receiving the adjudication information from an adjudication bot.

4. The computing platform of claim 1, wherein generating the adjudication notification for the patient mobile device comprises accessing a patient profile linking the patient identifier with a device identifier corresponding to the patient mobile device to determine the device identifier corresponding to the patient mobile device.

5. The computing platform of claim 1, wherein generating the adjudication notification for the patient mobile device comprises inserting, in the adjudication notification, a tokenized link corresponding to the event token associated with the post-adjudication event stored in the event token database.

6. The computing platform of claim 1, wherein sending the adjudication notification generated for the patient mobile device to the patient mobile device comprises sending the adjudication notification to the patient mobile device via a push notification service associated with the patient mobile device.

7. The computing platform of claim 1, wherein sending the adjudication notification generated for the patient mobile device to the patient mobile device comprises sending the adjudication notification to the patient mobile device via one or more text messages.

8. The computing platform of claim 1, wherein receiving the tokenized request for the post-adjudication user interface associated with the post-adjudication event from the patient mobile device comprises receiving request information identifying the event token associated with the post-adjudication event stored in the event token database.

9. The computing platform of claim 1, wherein receiving the post-adjudication response data associated with the post-adjudication event from the patient mobile device comprises receiving response data indicating patient authorization to complete the post-adjudication event.

10. The computing platform of claim 1, wherein receiving the post-adjudication response data associated with the post-adjudication event from the patient mobile device comprises receiving response data requesting a recurring event to complete the post-adjudication event.

11. The computing platform of claim 1, wherein receiving the post-adjudication response data associated with the post-adjudication event from the patient mobile device comprises receiving response data defining new patient profile information.

12. The computing platform of claim 1, wherein generating the formatted command directing the remote event processing server to complete the post-adjudication event comprises generating at least one command for the remote event processing server and formatting the at least one command for the remote event processing server in accordance with a web-based application programming interface (API) provided by the remote event processing server.

13. The computing platform of claim 12, wherein generating the formatted command directing the remote event processing server to complete the post-adjudication event comprises configuring the formatted command to direct the remote event processing server to debit a payment account linked to a patient associated with the post-adjudication event.

14. The computing platform of claim 1, wherein the memory stores additional computer-readable instructions that, when executed by the at least one processor, cause the computing platform to:
prior to receiving the adjudication information:
receive, via the communication interface, from a healthcare provider computing device, patient registration data associated with a first patient; and
generate a patient profile for the first patient based on the patient registration data received from the healthcare provider computing device.

15. The computing platform of claim 14, wherein the memory stores additional computer-readable instructions that, when executed by the at least one processor, cause the computing platform to:
after generating the patient profile for the first patient:
identify data requesting an initial event in the patient registration data received from the healthcare provider computing device; and
process the initial event by generating and sending one or more formatted commands to the remote event processing server.

16. A method, comprising:
at a computing platform comprising at least one processor, memory, and a communication interface:
receiving, by the at least one processor, adjudication information comprising a patient identifier, a visit identifier, and adjudication results data;
based on receiving the adjudication information, generating, by the at least one processor, an event token associated with a post-adjudication event, the event token associated with the post-adjudication event comprising a unique identifier linking the post-adjudication event to the patient identifier, the visit identifier, and the adjudication results data;
storing, by the at least one processor, the event token associated with the post-adjudication event in an event token database;
generating, by the at least one processor, an adjudication notification for a patient mobile device;
sending, by the at least one processor, via the communication interface, to the patient mobile device, the adjudication notification generated for the patient mobile device;
receiving, by the at least one processor, via the communication interface, from the patient mobile device, a tokenized request for a post-adjudication user interface associated with the post-adjudication event;
in response to receiving the tokenized request for the post-adjudication user interface associated with the post-adjudication event from the patient mobile device, generating, by the at least one processor, the post-adjudication user interface associated with the post-adjudication event based on the patient identifier, the visit identifier, and the adjudication results data associated with the adjudication information;
sending, by the at least one processor, via the communication interface, to the patient mobile device, the post-adjudication user interface associated with the post-adjudication event;
after sending the post-adjudication user interface associated with the post-adjudication event to the patient mobile device, receiving, by the at least one processor, via the communication interface, from the patient mobile device, post-adjudication response data associated with the post-adjudication event;
based on receiving the post-adjudication response data associated with the post-adjudication event, generating, by the at least one processor, a formatted command directing a remote event processing server to complete the post-adjudication event; and
sending, by the at least one processor, via the communication interface, to the remote event processing server, the formatted command directing the remote event processing server to complete the post-adjudication event.

17. The method of claim 16, wherein receiving the adjudication information comprises receiving the adjudication information from a healthcare provider computing device via the communication interface.

18. The method of claim 16, wherein receiving the adjudication information comprises receiving the adjudication information from an adjudication bot.

19. The method of claim 16, wherein generating the adjudication notification for the patient mobile device comprises accessing a patient profile linking the patient identifier with a device identifier corresponding to the patient mobile device to determine the device identifier corresponding to the patient mobile device.

20. One or more non-transitory computer-readable media storing instructions that, when executed by a computing platform comprising at least one processor, memory, and a communication interface, cause the computing platform to:
receive adjudication information comprising a patient identifier, a visit identifier, and adjudication results data;
based on receiving the adjudication information, generate an event token associated with a post-adjudication event, the event token associated with the post-adjudication event comprising a unique identifier linking the post-adjudication event to the patient identifier, the visit identifier, and the adjudication results data;
store the event token associated with the post-adjudication event in an event token database;
generate an adjudication notification for a patient mobile device;
send, via the communication interface, to the patient mobile device, the adjudication notification generated for the patient mobile device;
receive, via the communication interface, from the patient mobile device, a tokenized request for a post-adjudication user interface associated with the post-adjudication event;
in response to receiving the tokenized request for the post-adjudication user interface associated with the post-adjudication event from the patient mobile device, generate the post-adjudication user interface associated with the post-adjudication event based on the patient identifier, the visit identifier, and the adjudication results data associated with the adjudication information;
send, via the communication interface, to the patient mobile device, the post-adjudication user interface associated with the post-adjudication event;
after sending the post-adjudication user interface associated with the post-adjudication event to the patient mobile device, receive, via the communication interface, from the patient mobile device, post-adjudication response data associated with the post-adjudication event;
based on receiving the post-adjudication response data associated with the post-adjudication event, generate a formatted command directing a remote event processing server to complete the post-adjudication event; and
send, via the communication interface, to the remote event processing server, the formatted command directing the remote event processing server to complete the post-adjudication event.
